(19) United States
(12) Patent Application Publication
(10) Pub. No.: US 2009/0089198 A1
(43) Pub. Date: Apr. 2, 2009

(54) Method and Apparatus for Issue and Trade of Fractional Interest Real Estate Stock

(76) Inventor: Vladislav V. Kroutik, San Diego, CA (US)

Correspondence Address: PHILIP H. BURRUS, IV, 460 Grant Street, Atlanta, GA, 30312, US

(21) Appl. No.: 11/865,899

(22) Filed: Oct. 2, 2007

(51) Int. Cl. G06Q 40/00; G06Q 20/00

(52) U.S. Cl. 705/37; 705/39

(57) ABSTRACT

An electronic system—and associated method—for creating, marketing, and selling equity shares, represented by stock in individual real estate parcels is provided. A system and method for providing a liquid market for real estate stock is also provided. The system includes, a central controller, coupled to a network, having a trading system that processes the purchase and sale real estate parcel based stock, an investor interface with which investors communicate with the central controller, and a real estate owner interface with which real estate owners communicate with the server. A real estate owner creates, through the system a real estate stock offering, which is presented to a plurality of investors. Each investor may purchase the stock with a purchase commitment. The investors may later trade the real estate parcel stock via the system.

### BACKGROUND

1. Technical Field

This invention relates generally to a method and an apparatus for securitizing and financing real estate with real estate stock sold to one or more investors using electronic networks and automated trading systems.

2. Background Art

Private homeownership is a dream of every person and its benefits have been widely recognized and accepted. In the past decade the rate of homeownership has increased significantly. However, these recent advances have been difficult to sustain. High price appreciation and tightening lending practices are just some factors retarding the growth of this industry.

Another factor limiting the growth of home ownership is the complex process required to obtain conventional financing—such as a mortgage—for the purchase of a home. To purchase a home, an individual is required to put a cash down payment, have an acceptable credit rating, and possess a certain debt to income ratio among many other requirements. Further, the prospective buyer must fill out a myriad of lending forms and provide financial and personal information to a lender to be approved for a loan. This approval process is a prohibited hurdle for many. Recent developments in the sub-prime lending market, combined with higher interest rates and increasing real estate prices, have put the dream of home ownership out of the reach of many.

There is thus a need for an improved method and system for financing the purchase of real estate.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates one embodiment of a schematic block diagram illustrating a real estate stock sale management system in accordance with the invention.

FIG. 2 illustrates one embodiment of a block diagram showing a central controller in accordance with the invention.

FIG. 3 illustrates one embodiment of a block diagram showing a real estate owner interface in accordance with the invention.

FIG. 4 illustrates one embodiment of a block diagram showing an investor interface in accordance with the invention.

FIG. 5 illustrates one embodiment of a method for generating a real estate stock offer in accordance with the invention.

FIG. 6 illustrates one embodiment of a method for an acceptance of a real estate stock offer by a central controller in accordance with the invention.

FIG. 7 illustrates one embodiment of a method for an activation of a real estate stock offer in accordance with the invention.

FIG. 8 illustrates one embodiment of a method for a maintenance of active real estate stock offers in accordance with the invention.

FIG. 9 illustrates one embodiment of a method for selecting a real estate stock offer by an inventor in accordance with the invention.

FIG. 10 illustrates one embodiment of a method for binding of an investor commitment offer in response to a real estate stock offer in accordance with the invention.

FIG. 11 illustrates one embodiment of a method for binding of an investor commitment offer in response to a real estate stock offer in accordance with the invention.

FIG. 12 illustrates one embodiment of a method for completing a real estate stock offer and a payment between an investor and a real estate owner in accordance with the invention.

FIG. 13 illustrates one embodiment of a method for implementing a payment in accordance with the invention.

FIG. 14 illustrates one embodiment of a method for implementing counteroffers by an investor in accordance with the invention.

FIG. 15 illustrates one embodiment of a method for implementing counteroffers by an investor in accordance with the invention.

FIG. 16 illustrates one embodiment of a method for generating an investor sale offer or an investor purchase offer and subsequently being accepted by a central controller in accordance with the invention.

FIG. 17 illustrates one embodiment of a method for accepting and maintaining active investor sale offers and investor purchase offers in accordance with the invention.

FIG. 18 illustrates one embodiment of a method for accepting and maintaining active investor sale offers and investor purchase offers in accordance with the invention.

FIG. 19 illustrates one embodiment of a method for accepting and maintaining active investor sale offers and investor purchase offers in accordance with the invention.

FIG. 20 illustrates one embodiment of a method for completing a transaction between investors of investor purchase offer and investor sale offer in accordance with the invention.

FIG. 21 illustrates one embodiment of a method for maintaining real estate stock offers which pay dividends in accordance with the invention.

FIG. 22 illustrates one embodiment of a schematic block diagram illustrating a method of real estate stock sale management system in accordance with the invention.

FIG. 23 illustrates one embodiment for method for creating, marketing, and selling equity shares in accordance with the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to securitizing and financing real estate with real estate stock sold to one or more investors. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

Embodiments of this invention relate generally to a method and apparatus for facilitating an original issue of stock that is secured by a fractional equity interest in an underlying individual parcel of real estate. The individual parcel of real estate is not a pool or combined holding of a Real Estate Investment Trust (REIT), but is rather a single parcel of real estate such as a private residence or commercial site. Embodiments of the invention also facilitate sale of the stock to public investors across an automated exchange. This system includes facilitation of an active, on-going, multilateral market between investors. Embodiments of the invention allow prospective purchasers to receive money from a plurality of investors for the purchase of an individual parcel of real estate. Embodiments of the invention also allow real estate owners to extract money from a parcel that is already owned by issuing equity shares in that property. Further, investors are able to actively trade the issued stock with other investors on the exchange. One advantage of one embodiment of the invention is that prospective buyers of real estate parcels are able to receive money without mortgaging their property.

In one embodiment, communications between real estate owners and investors are conducted using an electronic network and central controller. The term “real estate owner” will be used herein to refer to either prospective purchasers of a real estate parcel or to owners of real estate parcels looking to extract money by selling equity shares in an already owned real estate parcel. A “parcel” is used herein to refer to a single piece of real estate, e.g. a residential home or a singular business property.

A real estate owner who wishes to sell an equity interest in an individual real estate parcel accesses the central controller, which may be located at a remote server across a network. The real estate owner then creates a Real Estate Stock Offer (RESO) to sell an equity interest in the parcel. In one embodiment, the equity interest includes a percentage of the value of the parcel along with any improvements. The investor then realizes a return when the parcel is sold. In the initial stock offer, the owner and investor may negotiate sale date, monetary amount to be transferred, and other conditions as required by the investor.

By way of example, a typical RESO might specify that the real estate owner wants to receive $100,000. This money may be for the purchase of another parcel. The money may be for other uses as well. Regardless of use, the real estate owner, by issuing a RESO, has opted to obtain money by issuing equity shares in a real estate parcel rather than taking out a second mortgage or equity line of credit. The RESO may further state that the real estate owner will not sell the parcel for at least five years. Such a time limitation ensures that an investor will have a minimum holding time available for equity appreciation. In one embodiment, the real estate owner will not be obligated to make any payments to the investor during the duration of the holding time. Payments will be made only at the sale of the property. At that point, the real estate owner will have to pay the investor the investor's share of the sale price. In most RESOs, the real estate owner will be responsible for the maintenance of the property, payment of real estate taxes, insurance and all other expenses of the property.

Once the RESO has been created, the real estate owner then attaches user identification to the RESO. The RESO is then transmitted to the central controller across the network. Examples of transmission schemes of the present invention include a world-wide-web interface, such as a web browser or portal, electronic mail, voice mail, facsimile, or postal mail. The system may attach standard legal provisions and boilerplate language to the RESO, and may further “fill in the gaps” to complete the RESO.

Before transmitting the RESO to potential investors, the central controller first authenticates the real estate owner's unique identification number. In one embodiment, this authentication is made possible by a real estate owner database, which includes publicly available information about the real estate owner. The central controller may require additional verification by requesting that the real estate owner provide a social security number or other personal information. This personal information may be used for credit verification, existing debt obligation verification, income sources and expense verification. The personal information may also be used to ensure that the real estate owner has sufficient debt-free equity available to cover the money requested in the RESO.

Once the verification process is complete, the central controller then assigns a unique tracking number to the RESO. The RESO is then presented globally so that it becomes available for viewing by potential investors. The RESO may be categorized with other RESOs, perhaps by property location, to make it easier for potential investors to identify relevant RESOs. Thus, an investor interested in RESOs in the state of Florida could log onto a web portal and paruse a listing of Floridian RESOs. In one embodiment, the investor may have to be pre-qualified to access RESO listings.

If, after reviewing a particular RESO, a potential investor wishes to participate in the RESO, the investor communicates his interest to the central controller. The central controller then timestamps the interest message and authenticates the identity of the investor, as well as his capacity to deliver the funds set forth in the RESO. The central controller then verifies that the RESO is “active” and available for purchase. If a RESO is available for purchase by only one investor, it is “completed” when the first qualified investor accepts it. Subsequent investors will not be able to purchase a “completed” RESO, but may be added to a corresponding waiting list.

If a RESO is available for purchase by many investors, subsequent investors will be able to purchase the same RESO until the funding set forth in the RESO is obtained. Once this funding is obtained, the RESO is marked “completed” and additional investors may be added to a waiting list. When an investor purchases an active RESO, the central controller assigns a unique tracking number to the investor's purchase. The purchase details are then stored in a database. Once purchased, the real estate owner and investor become parties to a legally binding contract.

In another embodiment, the central controller manages payments between the real estate owner and investor automatically. Various methods of payment may be used in accordance with the invention, including payment by credit cards, personal checks, electronic funds transfer, debit cards, and digital cash. The payment system may also involve the use of an escrow account associated with the real estate owner wherein a trustee maintains funds advanced by the investor until the RESO is complete. Moreover, payment timing may be varied, depending upon application. For instance, the real estate owner may receive funds immediately after the investor commits funds. Alternatively, payment may be delayed until after the real estate owner performs and signs all required documents and they are recorded.

In another embodiment of the invention, an investor may be given an option of responding to a RESO by issuing a counteroffer with conditions different from the original. In such a scenario, the investor transmits the counteroffer to the central controller. The central controller, in turn, forwards the counteroffer to the real estate owner. Upon receiving the counter offer, the real estate owner is given the option of accepting the counteroffer. Where the counter offer is accepted, the investor becomes bound to the investor for the terms of the counter offer.

In one embodiment, the RESO may be constructed to pay dividends. The dividends may be used to enhance the attractiveness of a RESO. Where dividends are used, the central controller maintains dividends obligations and facilitates transactions required for payment. The central controller may also record dividend payments on the exchange.

While one embodiment of the present invention is intended for networked use, embodiments of the present invention may also take off-line forms. Instead of using electronic mail or web-based servers, for example, real estate owners and investors may communicate with the central controller via telephone, facsimile, postal mail, or another off-line communication tool. For instance, real estate owners may use telephones to create RESOs (with or without the assistance of live agents). Similarly, potential investors may use a telephone to browse and bind RESOs.

Once RESO is completed, an investor may use the system to sell the equity interested obtained to other investors. The investor does this by communicating an offer to sell the equity interest to the central controller and specifying selling price and time of offer expiration. Other investors may have an interest in purchasing existing real estate stock traded on an exchange. Such investors may communicate their offer to purchase to the central controller, specifying purchase price and time of offer expiration. The central controller monitors orders received from buyers and sellers. Where a match is found, the controller executes transaction and real estate stock ownership rights are transferred from seller to buyer. The controller instructs a settlement system to transfer funds between parties. During such a transaction, the real estate owner who originally sold real estate shares is unaffected.

In one embodiment, security protocols are used. For example, cryptographic protocols may be used to authenticate the identity of buyers and/or sellers, as well as to verify the integrity of buyer and seller communications with the central controller. Using cryptography or other technologies such as biometrics, the central controller can make it significantly more difficult for unauthorized persons to tamper with the system.

Similarly, the system in one embodiment works to maintain buyer and seller anonymity.

For numerous privacy and competitive reasons, buyers and sellers often prefer not to have their identities revealed to the general public when engaging in commercial transactions. Embodiments of the invention offer such protection through the use of identification numbers stored in a database secured by the central controller.

One embodiment of a central controller suitable for use with the invention includes three controller components, which embody six systems: a membership system, a pricing system, a RESO system, a trading system, a clearing system and a compliance system. The membership system authenticates the identity of real estate owners and investors. The pricing system prices new RESOs or existing real estate stock. The RESO system facilitated creation of the RESO and also posts the RESO to investors. The trading system records and facilitates real estate stock trades. The clearing system settles money between all parties once transactions are completed. The compliance system stores a log of all activities in the central controller and performs system and compliance audits. This multi-system configuration allows for ease of controller distribution among specialized servers.

Where disputes arise, one embodiment of the invention offers a mechanism for dispute resolution. In one embodiment, the system attaches binding arbitration clauses to RESOs. The central controller may serve as an arbitrator or may refer the dispute to a third-party arbitrator for resolution.

Embodiments of the invention provide advantages not found in the prior art. First, the system provides the ability for real estate owners to access to money from plural investors by selling equity shares in a single real estate parcel. Next, the system allows real estate owners to reach a large number of remotely located investors—investors who normally would not be able to afford to find the real estate parcel associated with the RESO. Third, the system allows small investors to obtain leverage by participating in the appreciation of a real estate parcel that is worth substantially more than their investment by providing the real estate owner with a fraction of funds set forth in the RESO. Next, the system allows real estate owners to issue real estate stock and globally communicate the stock offer to investors. Transaction costs are minimal, and the system provides liquidity for the real estate stock sold with a RESO.

The real estate owner offering stock remains the owner of the parcel. The system maintains a conformance record of all covenants required by the RESO. When the parcel is finally sold, the system receives money from the sale according to original RESO and distributes the appropriate funds to the investors on record.

Thus, embodiments of the invention provide a vehicle for permitting investors to participate in fractional ownership of home equity. It is a goal of embodiments of the present invention to provide a robust system that matches real estate owners having a desire to raise money with investors capable of providing financing. The power of a central controller to field real estate stock offers from real estate owners and investors, communicate those offers globally in a format which can be efficiently accessed and analyzed by other investors, effectuate performance of resulting sale of real estate stock, trade between parties, resolve disputes arising from those transaction, and maintain billing, collection, authentication, and anonymity makes the present invention an improvement over conventional systems.

As will be illustrated and described herein, an electronic system for creating, marketing, and selling equity shares, represented by stock in individual real estate parcels, between an owner of the individual real estate parcel and at least one of a plurality of investors is provided. The system includes a central controller having a network interface coupled to a network. The central controller includes and facilitates a trading system configured to process purchase and sale of one of the real estate parcel based stock offerings or the equity. The central controller also includes an investor interface coupled to the network interface across the network. The investor interface is configured to receive investor input. A real estate owner interface, which is a part of the central controller and is coupled to the network interface across the network, is configured to receive real estate owner input.

The central controller further comprises a pricing system that is configured process investor requests received by the electronic system for real estate parcel based stock offering prices. The pricing system is further configured to deliver one or more real estate parcel based stock offerings in response to the investor requests. The pricing system also is configured to process offering requests received by the electronic system for stock offerings, and to deliver one or more stock offering options in response to the offering requests.

A clearing system, also a part of the central controller, is configured to process financial transactions associated with the purchase and sale of the real estate parcel based stock offerings. A compliance system maintains records of central controller transactions. A real estate stock offering system configured to process requests by real estate owners to initiate real estate parcel based stock offerings.

A real estate information system communication coupling, which may be connected to the central controller across the network between the central controller and a real estate information system, is configured to receive information validating real estate parcel value, existing debt, and property conditions. A bank communication coupling, connected across the network between the central controller and a bank, is configured to receive information validating funds from the bank. A credit agency communication coupling, connected across the network between the central controller and a credit agency, is configured to receive information validating real estate owner personal information from the credit agency.

A membership system, which is included in one embodiment of the central controller, works with a real estate owner database and an investor database to authenticate an identity of at least one real estate owner and at least one investor by matching identities of real estate owners stored in the real estate owner database with certain system users. The membership system may also match identities of investors stored in the investor database with other certain system users.

A real estate stock offering database, which is accessible by the central controller, is configured to invoke the real estate stock offering system to create a plurality of stock shares corresponding to the real estate parcel information, and to store them in a real estate stock offering database. The electronic system of claim 8, further comprising a plurality of databases, accessible by the central controller, the plurality of databases comprising at least a purchase commitment database for storing purchase commitments of the real estate parcel based stock offerings, and a clearing database for storing transaction data relating to the real estate parcel based stock offerings. Other databases may be included as well, each database being accessible by the central controller, including at least a purchase commitment database for storing purchase commitments of the real estate parcel based stock offerings, and a clearing database for storing transaction data relating to the real estate parcel based stock offerings. Additional databases include a contract detail database, a real estate stock option database, and a payment database an audit database, an escrow database, and an investor offers database.

The central controller, upon receiving a request from the investor interface, is configured to invoke the pricing system to retrieve one or more stock shares from the real estate stock offering database, associate a price with the one or more stock shares, and to deliver the price to the investor interface. Upon receiving a purchase commitment from the investor interface, the central controller is configured to invoke the trading system to generate an identifier specifying at least a financial account. The identifier is associated with the purchase commitment, which is stored with the identifier in the purchase commitment database. Once the purchase commitment is stored in the purchase commitment database, the central controller is configured to invoke the clearing system to transfer funds from an investor account to a real estate owner account.

A method for creating, marketing, and selling equity shares, represented by stock in individual real estate parcels, between an owner of the individual real estate parcel and at least one of a plurality of investors, is also described. The steps of the method include providing a networked, electronic, exchange apparatus having a central controller, as described above, and receiving electronic real estate parcel data from the owner interface, where the electronic real estate parcel data comprising at least an address and an appraised value amount. Once the electronic real estate parcel data is received, the central controller performs the step of generating a real estate parcel based stock offer associated with the electronic real estate parcel data and delivers the real estate parcel based stock offer to the investor interface. In one embodiment, the real estate stock parcel based stock offering comprises at least a minimum purchase amount and an offering duration.

The investors then get involved and transmit, through the investor interface, purchase commitments. Thus, the central controller performs the step of receiving at least one purchase commitment from the investor interface in response to the step of delivering the real estate parcel based stock offer. The central controller also receives an electronic financial account identifier associated with the at least one purchase commitment from the investor interface and executes an electronic transfer of funds via the electronic financial account identifier. Once the purchase commitment is received, the central controller executes the step of determining whether the purchase commitment exceeds the minimum purchase amount. The central controller also executes the step of determining whether the offering duration has expired prior to receipt of the at least one purchase commitment, and the steps of validating the electronic real estate parcel data and validating the at least one purchase commitment. The central controller is further responsible for delivering the at least one purchase commitment to the owner interface upon receiving the at least one purchase commitment, receiving additional transaction details from the owner interface; and generating, electronically, a counteroffer and delivering the counteroffer to the investor interface. All transactions may be tracked throughout the process. For instance, the central controller may perform the steps of adding a tracking number and time stamp to one of the real estate parcel based stock offering or the at least one purchase commitment.

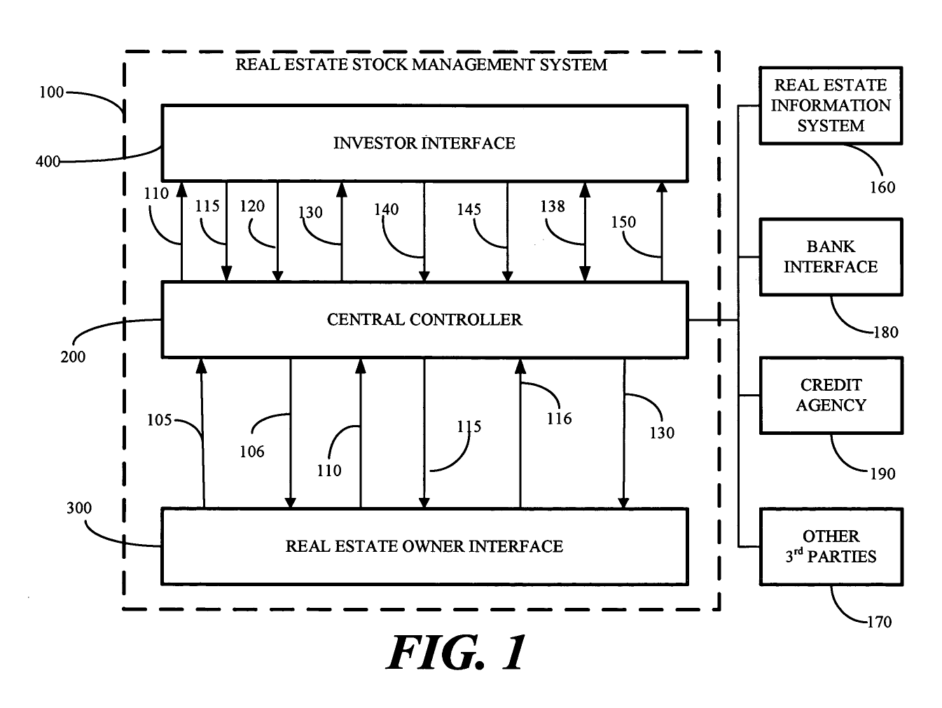

Turning first to FIG. 1, illustrated therein is one embodiment of an electronic system 100 for creating, marketing, and selling equity shares, represented by stock in individual real estate parcels, between an owner of the individual real estate parcel and at least one of a plurality of investors. The system 100 will be referred to herein as a “Real Estate Stock Exchange” (RSE) system for discussion purposes. In one embodiment, the RSE includes a central controller 200, a real estate owner interface 300, and an investor interface 400.

The system 100 receives real estate details 105 from real estate owner and provides the real estate owner with plurality of a real estate stock offer options for sale 106. The system 100 further receives selected RESOs 110 from real estate owners, then makes them available for viewing by potential investors. The system 100 allows investors to purchase RESOs as one or more real estate stocks. Thus, a real estate owner is able to communicate his initial offer to share a fraction of the appreciation and commitment associated with an individual real estate parcel to an investor. Such an offer provides the investor with the confidence that if he purchases shares, he will benefit from the corresponding financial rewards. Once RESO 110 has been purchased by investors, the system 100 allows investors to buy or sell real estate stocks in an active, liquid market. The stocks may be owned by investors and offered in an investor sale offer 140, or may be solicited by other investors with investor purchase offer 145.

FIGS. 1 through 4 illustrate one preferred architecture for a system 100 in accordance with the invention. As shown in FIG. 1, the system 100 includes a central controller 200, a real estate owner interface 300, an investor interface 400, a real estate information system 160, a bank interface 180, a credit agency 190, and a connection to various other third parties 170. Each of these connections are referred to as a “node.”

Each node is connected to another via a network connection, such as an Internet connection. The connection may be accomplished using a public switched telephone or broadband network, such as those provided by a local or regional telephone operating company. Communication connections may also be provided by dedicated data lines, cellular, Personal Communication Systems (“PCS”), microwave, or satellite networks. The nodes serve as the input and output gateways for communications with central controller 200.

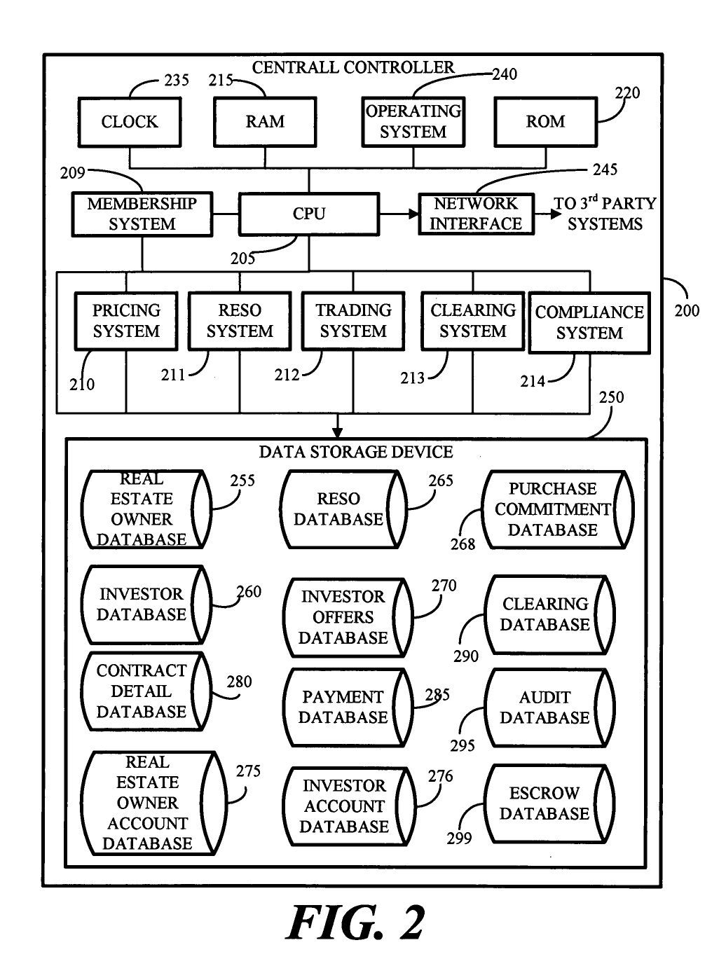

Turning now to FIG. 2, the central controller 200 includes central processor (CPU) 205, RAM 215, ROM 220, the membership system 209, the pricing system 210, the RESO system 211, the trading system 212, the clearing system 213, the compliance system 214, and other components, such as a clock 235, an operating system 240, a network interface 245, and a data storage device 250. Each of the systems may comprise executable software, functional with the CPU, and stored in memory. A conventional server computer with sufficient memory and processing capability may be used as central controller 200. In one embodiment the central controller 200 operates as a web server, both receiving and transmitting RESOs 110 generated by real estate owners. The central controller 200 may also receive and transmit ISOs 140 and IPOs 145.

In one embodiment, the central controller 200 is configured to handle a high volume of transaction processing. The central controller 200 also performs a significant number of mathematical calculations in processing communications and database searches. One example of a processor suitable for use as the CPU 205 is a Pentium microprocessor, such as the Single Quad-Core Intel Xeon 1200 2.4 GHz, commonly manufactured by Intel Inc. Equivalent processors include Dual-Core 64-bit AMD Opteron processors with 2×1 MB L2 Cache 2.80 GHz commonly manufactured by AMD.

While the various systems may comprise executable software, each may include its own processor as well. For instance, the membership system 209, pricing system 210, RESO system 211, trading system 212, clearing system 213, and compliance system 214 may each have their own dedicated microprocessor (such as the Intel Xeon). Alternatively, these systems may be configured as part of the central CPU 205.

The membership system 209 authenticates the identity of real estate owners and investors. It uses a real estate owner database 255 and an investor database 260 to match identities of users that communicate with central controller 200. The pricing system 210 processes real estate owner and investor requests for pricing real estate stock. Real estate owners provide real estate details 105 and receive one or more real estate stock offer options in return. Investors provide a real estate stock query 138 and receive one or more real estate stocks meeting their query criteria in return.

The RESO system 211 facilitates creation of the RESO. The RESO system 211 further processes the sale of RESOs 110 and purchase commitments 120. This system provides all necessary operations for initial real estate stock issue by investor. The trading system 212 processes all investor trading on existing real estate stock, including Investor Sale Offers (ISO) 140 and Investor Purchase Offers (IPO) 145.

The clearing system 213 processes all transactions which have a “pending” status. This system communicates with bank interface 180 to complete payment processing if needed. The compliance system 214 keeps track of every transaction by central controller 200, thus maintains a history of every transaction. This system also provides reports to real estate owners and investors on all of their activities and monitors for various compliance issues.

The data storage device 250, which may include hard disk, magnetic disk, optical storage units, CD-ROM drives, or flash memory, contains databases used in the processing of transactions. These databases include the real estate owner database 255, the investor database 260, the RESO database 265, the purchase commitment database 268, the investor offers database 270, the real estate owner account database 275, the investor account database 276, the contract detail database 280, the payment database 285, the clearing database 290, and the audit database 295. In a preferred embodiment database software such as Microsoft SQL Server 2005, manufactured by Microsoft Corporation, is used to create and manage these databases.

The real estate owner database 255 maintains data on real estate owners with fields such as unique identifier, name, address, phone number, ID number, social security number, electronic mail address, credit history, past system usage, etc. This information is obtained when the real estate owner first registers with the system, or immediately prior to posting his first RESO 110.

The real estate owner account database 275 tracks all information pertaining to the real estate owner's account with fields such as real estate owner's name, bank and credit account numbers, and debit or credit transactions. Real estate owner payments for RESOs 110 may be sent to this database. This database may be a pointer to account data stored at the real estate owner's bank.

The investor database 260 maintains data on investors with fields such as unique identifier, name, contact information, real estate preferences. Contact information comprises a phone number, web page URL, blog address, pager number, telephone number, electronic mail address, voice mail address, facsimile number, or other contact indicia. Upon registration, the investor may be required to demonstrate evidence of a financial ability to purchase RESOs 110 or IPOs 145.

The investor account database 276 tracks all information pertaining to the investor's account with fields such as investor's name, unique identified, bank and credit account numbers. This database may be a pointer to account data stored at the investor's bank.

The RESO database 265 tracks all RESOs 110 with fields such as status, tracking number, date, time, amount, pay offs, expiration date, conditions, and real estate owner identification number. This database is valuable in the event of disputes between real estate owners and investors regarding payment, because details of the offer can be produced.

The purchase commitments database 268 tracks all purchase commitments 120. The structure of this database is similar to RESOs database 265, plus the addition of a field for a RESO tracking number to facilitate purchase commitments 120 being correlated with a particular RESO 110.

The investor offers database 270 tracks all ISOs 140 and IPOs 145. This database maintains data with fields such as real estate stock identified, status, tracking number, date, time, amount, pay offs, expiration date, conditions, and investor identification number.

The contract detail database 280 contains form background provisions for inclusion in RESOs 110, ISOs 140 and IPOs 145. These form provisions effectively fill the details of conditions specified by the real estate owner, details of RESO, and specifying the generic contract details common to most RESOs 110. For an ISO 140 or an IPO 145, the contract detail database 280 fills in the details of conditions specified by the investor and the corresponding RESO 110.

The payment database 285 tracks all payments made by the investors with fields such as investor name, investor unique identifier, amount of payment, associated RESO 110, iso 140 or IPO 145 tracking number. This database may also store bank account information of investors.

The clearing database 290 tracks all records of transaction between real estate owners and investors, investors and investors and status of the transaction. Records include fields such as unique identifier, amount of payment, and associated RESO 110, iso 140, or IPO 145 tracking number.

The audit database 295 stores transactional information relating to the posting of RESOs 110, purchase commitments 120, ISOs 140, IPOs 145, and any other transaction processed by the central controller 200. This database allows such data to be retrieved for later analysis.

The escrow database 299 temporary holds investor funds before they are placed in the account of real estate owner in real estate owner account database 275. These funds may also be transferred from the escrow account database 299 to the investor account database 276.

The network interface 245 is the gateway to communicate with investors, real estate owners, and third parties 170 or third party systems such as the real estate information system 160, the bank interface 180, or the credit agency 190. Conventional internal or external modems, or network cards, may serve as the network interface 245. In one embodiment, the network interface 245 supports modems at a range of baud rates from 1200 upward, but may combine such inputs into a T1 or T3 line if more bandwidth is required. In one preferred embodiment, the network interface 245 is connected with the Internet and/or any of the commercial on-line services such as America Online, DSL, or Cable Internet, thereby allowing investors and real estate owners to access the system 100 from a wide range of on-line connections. The system 100, in one embodiment, is platform independent and utilizes open standards based on commonly understood Internet protocols. The system 100 also supports multiple languages. The system 100 may alternatively be configured as a voice mail interface, web site, bulletin board, or electronic mail address.

While the paragraphs above describe generally a single computer acting as central controller 200, it will be obvious to those of ordinary skill in the art having the benefit of this disclosure that system functionality can be distributed across a plurality of computers. In one embodiment, the central controller 200 is configured in a distributed architecture, where the databases and corresponding processors are housed in separate units or locations. Some controllers perform the primary processing functions and contain at a minimum RAM, ROM, and a general processor. Each of these controllers is attached to a WAN hub which serves as the primary communication link with the other controllers and interface devices. The WAN hub may have minimal processing capability itself, serving primarily as a communications router. Those skilled in the art having the benefit of this disclosure will appreciate that an almost unlimited number of controllers may be supported. This arrangement can yield a dynamic and flexible system, which may be less prone to multiple processor hardware failures.

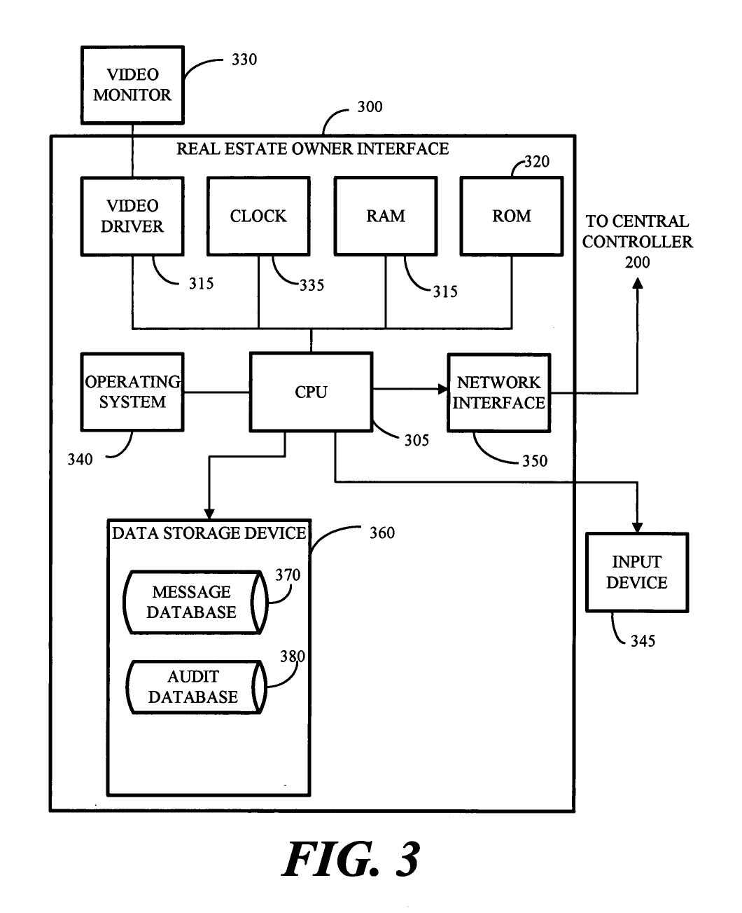

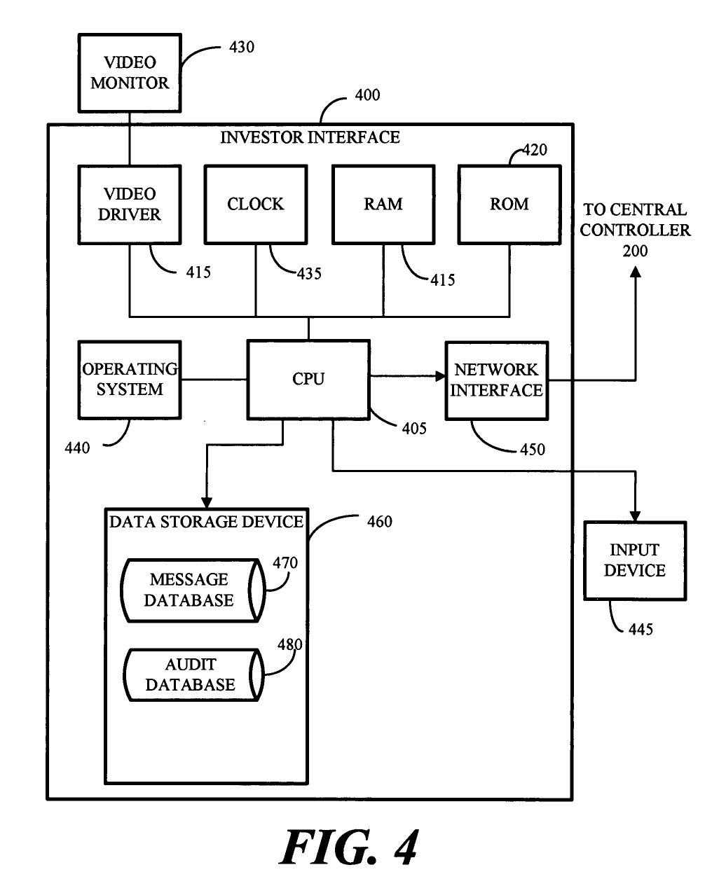

Turning now to FIGS. 3 and 4, illustrated therein are the real estate owner interface 300 and investor interface 400, respectively. In an exemplary embodiment, both the real estate owner interface 300 and the investor interface 400 comprise conventional personal computers having an input device, such as a keyboard, mouse, or conventional voice recognition software package; a display device, such as a video monitor; a processing device such as a CPU; and a network interface such as a modem or network card. These devices interface with central controller 200 across a network. Alternatively, real estate owner interface 300 and investor interface 400 may comprise other devices, such as voice mail systems, fax machines, pagers, PDAs, or other electronic or voice communications systems.

Referring to FIG. 3, the real estate owner interface 300 includes a central processor (CPU) 305, RAM 315, ROM 320, a clock 335, a video driver 325, a video monitor 330, an operating system 340, an input device 345, a network interface 350, and data storage device 360. A Xeon microprocessor such as the Intel Core 2 Duo E6700 described above may be used for CPU 305. The clock 335, in one embodiment, is a standard chip-based clock which can serve to timestamp a RESO 110 or a purchase commitment 120.

The data storage device 360 is a conventional magnetic-based hard disk storage unit such as those manufactured by Maxtor. The message database 370 may be used for archiving RESOs 110, ISOs 140 and IPOs 145, while the audit database 380 may be used for recording payment records and communications with central controller 200.

Referring now to FIG. 4, the investor interface 400 includes a central processor (CPU) 405, RAM 415, ROM 420, a clock 435, a video driver 425, a video monitor 430, an operating system 440, an input device 445, a network interface 450, and a data storage device 460. All of these components may be identical to those described above in reference to FIG. 3.

Communications between the nodes and the central controller 200 may be enabled by various commercial software applications available today. Microsoft Outlook, manufactured by Microsoft Corporation, for example, provides editing tools for the creation of messages as well as the communications tools to route the message to the appropriate electronic address. When the central controller 200 is configured as a web server, conventional communications software such as the Internet Explorer web browser from Microsoft Corporation may also be used. The real estate owner interface 300 and investor interface 400 may use the Internet Explorer browser to transmit RESO 110, investor purchase commitments 120, or purchase confirmations 130.

In one embodiment of the invention, transactions between real estate owners and investors take place across a network, with the central controller 200 acting as a web server. The real estate owner logs on to the central controller 200 and creates a RESO as described above. The real estate owner then disconnects from the network. The central controller 200 makes the RESO available to potential investors by posting it on, for example, the web page of the central controller 200. The central controller 200 also performs periodic maintenance to ensure that active RESOs have not expired.

Investors transmit purchase commitments 120 electronically to the central controller 200, which in turn saves them in the purchase commitment database 268. Once a sufficient number of purchase commitments 120 for a given RESO have been accumulated, i.e. a sufficient number to financially cover the amount requested by the RESO, the central controller 200 clears the RESO 110 and transfers payment to the real estate owner.

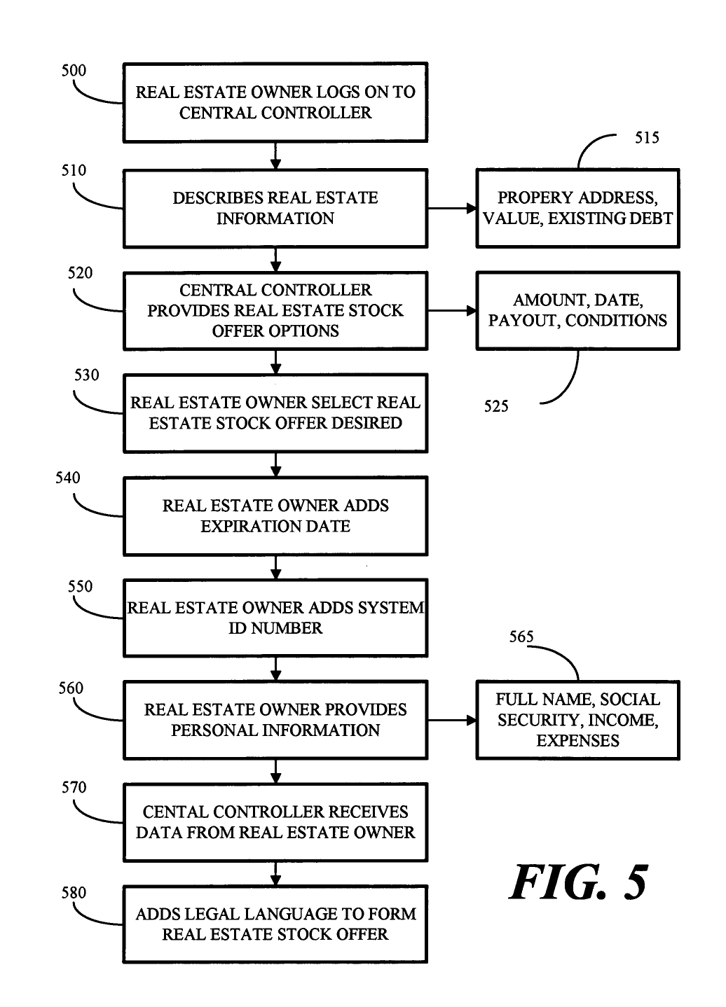

Turning now to FIG. 5, illustrated therein is one embodiment of a method by which the real estate owner formulates a RESO. At step 500, the real estate owner logs on to the central controller 200 by way of the real estate owner interface 300, thereby establishing a communication link. It should be noted that the real estate owner may be an individual, a corporation, a partnership, a government, or any other entity. In one embodiment, the central controller 200 provides a page on the World Wide Web, thereby allowing the real estate owner to communicate with the central controller 200 through the interface of conventional web browser software such as Internet Explorer, manufactured by Microsoft Corporation.

At step 510, the real state owner provides the real estate detailed information for the real estate upon which he wants to issue RESO. As shown in box 515, information might include property address, residential or commercial type, year purchased, current value, amount of existing debt, etc. After the information is provided, a form is displayed on video monitor 430 of real estate owner interface 300.

At step 520, the real estate owner receives a list of options for RESOs available to him. These options are prepared by the pricing system 210 of the central controller 200. As shown in the box 525, offer options might include offer amount, commitment date, payoff, and so forth. A homeowner, for example, might want to raise money for his daughter to go to college. If he owns a house that he purchased 20 years ago, he may use a RESO to extract funds from that parcel. In accordance with one embodiment, he would enter his home address, estimated property value, amount of any existing mortgage, his income, assets, expenses, etc. The real estate owner simply fills in the blanks. The real estate owner then reviews options for real estate stock offers 520 and chooses the one that most closely meets his needs. This option would be selected and the corresponding RESO generated.

As indicated in box 525, real estate options could include the provision that stock can be re-purchased, minimum term date, total amount offered, percentage of equity share, etc which are conditions of the option. Real estate stock offer term and conditions may be modified so as to allow the real estate owner to tailor RESO for his specific needs. The RESO may also be based on one or more owner conditions. For example, one condition might state that four out of five other specified conditions must be met. Conditions may be based on external events. For example, the real estate owner may be required to obtain prior permission from the central controller 200 if he wants to refinance, sell or improve the parcel upon which equity interests are sold.

RESO stock availability is not limited to current owners of parcels. Prospective buyers may use the system to obtain financing for a purchase as well. For example, where an individual wants to become a real estate parcel owner, they may use a RESO to finance the purchase of the parcel. In such a scenario, the RESO options might include real estate stocks that pay dividends.

In another example, the prospective borrower might want to pay off existing debt or mortgage balances on a parcel. In such a scenario, real estate owner may issue a RESO that includes a mix of real estate stock without dividends and real estate stock without dividends.

The real estate owner selects a RESO option at step 530. At step 540, the real estate owner may add an expiration date to the RESO if desired. This expiration date option allows the real estate owner to post a RESO without worrying about being bound after a date certain, for example when his needs may have changed.

At step 550, the real estate owner attaches his name or a unique system identification number to the RESO. The central controller 200 provides the identification number when the real estate owner registers for the service. Alternatively, the real estate owner chooses the unique identification number and then registers with central controller 200 by phone. The central controller 200 maintains a list of the unique identification numbers in the real estate owner database 255. Where less security is required, the user's social security number could serve as the unique identification number, as it offers the advantages of being both unique and easily remembered.

At step 560, the central controller 200 may ask the real estate owner to provide additional personal information. As indicated in box 565, the personal information may include the real estate owner's full name, social security number, credit scores, income sources, asset information, expenses, and so forth.

The real estate owner then transmits the information to the central controller 200 at step 570. At step 580, boilerplate language is added to the RESO to complete the RESO. The boilerplate language is stored in the contract detail database 280.

As an alternative to the network interface, the real estate owner may also transmit RESO data via electronic mail, voice mail, facsimile, or postal mail transmissions. With voice mail, the real estate owner calls the central controller 200 and leaves RESO data in aural form. The RESO information may be transcribed into digital text at the central controller 200, or may alternatively be made available to potential investors in the aural format. In a mail enabled embodiment, the central controller 200 acts more like a router, directing RESOs to the potential investors, and creating multiple copies of RESOs when necessary. The RESOs may also be posted to bulletin boards or web pages operated by the central controller 200.

As noted, the central controller 200 supports a plurality of transmission methods, allowing for a wide variety of formats of RESOs. Some formats may be changed, however, before further processing by the central controller 200. By way of example, the RESOs may be transmitted by mail in paper form, may be scanned and digitized using optical character recognition software to create digital text. These embodiments are more fully described in the off-line embodiment described later.

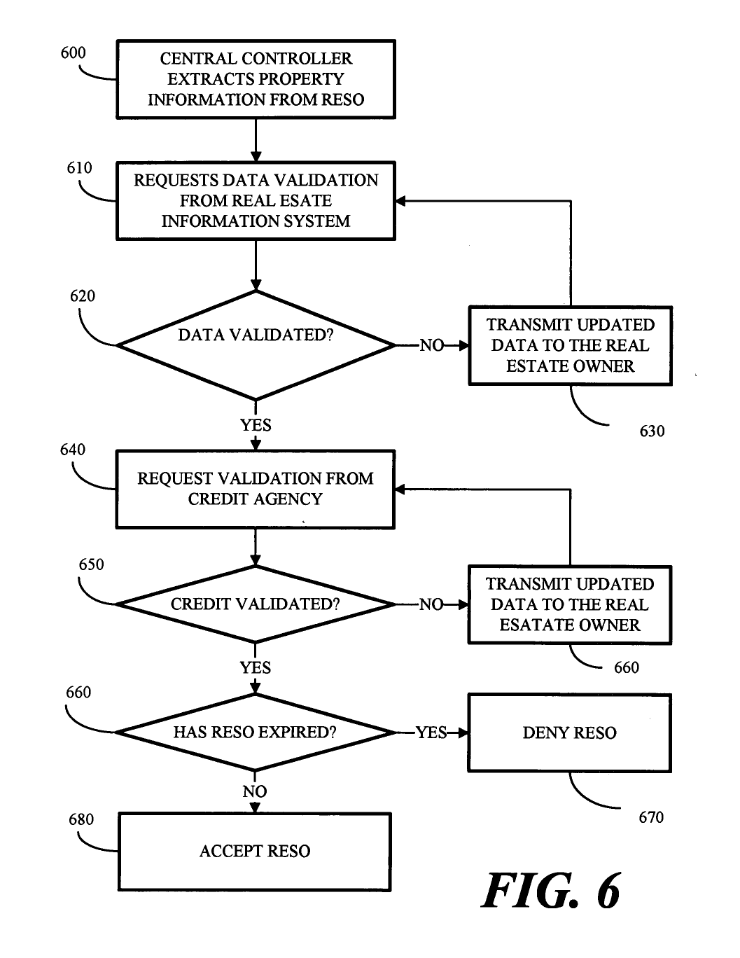

Referring now to FIG. 6, illustrated therein is a method of processing a RESO in the central controller 200 once the real estate owner has transmitted the RESO. When the RESO is received, the central controller 200 validates all information entered by the real estate owner to ensure that the monetary amounts and all conditions are justified. This occurs before the central controller 200 makes the RESO available to potential investors.

At step 600, the central controller 200 extracts real estate property information from the RESO. At step 610, central controller 200 submits property information for data validation to the real estate information system 160. One function of this submission is to validate the stated real estate value, existing debt, and property condition set forth in the RESO. The central controller 200 essentially checks to see if there is evidence to support the RESO assertions to investors.

At step 620, the real estate information system responds to the data validation, indicating whether all information has support evidence, or whether there is reason to believe that the information is inaccurate. If there is cause to believe that the information is not accurate, data supporting this cause is transmitted to real estate owner at step 630.

The real estate owner then has the opportunity to update the information or provide support for the original information. Where the RESO property information is updated or support is transmitted, central controller 200 then resubmits the request for data validation at step 610. At step 640, the central controller 200 requests a credit agency 190 to validate real estate owner personal information, such as social security, credit scores, debt, income and other information, which may be extracted from the RESO. If the personal information is not accurate as disclosed in the RESO, an indication of the inaccuracy is transmitted to real estate owner at step 650. As with the real estate information, the real estate owner has the opportunity to correct or validate the information. Once the real estate owner has validated or corrected the personal information, central controller 200 then resubmits the request for data validation to the credit agency 190 at step 640.

With the validation/correction processes transpiring, the central controller 200 may check the RESO to see if it has expired at step 660. If expired, the RESO is rejected at step 670 and returned to the real estate owner. If the RESO has not yet expired, it is accepted at step 680.

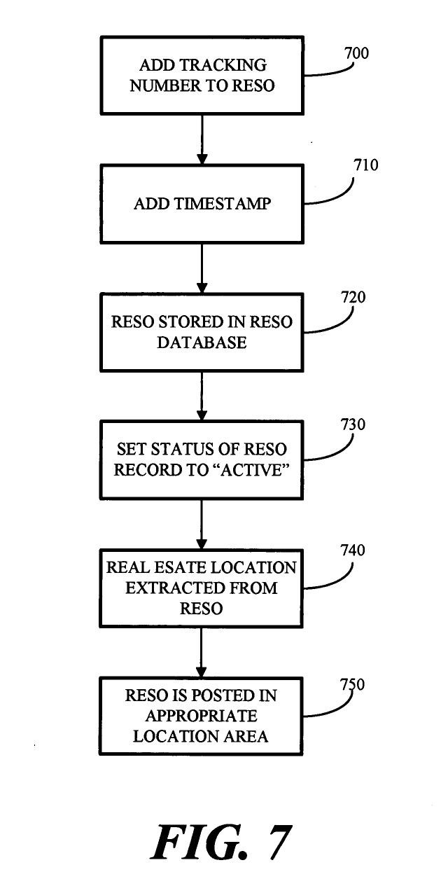

Referring now to FIG. 7, there is illustrated one method of activating and making public a RESO in accordance with embodiments of the invention. Specifically, the central controller 200 activates the RESO and makes it available to potential investors via the RESO system 211.

At step 700, a unique tracking number is added to the RESO. Additionally, the RESO system 211 timestamps the RESO at step 710 and stores the RESO in the RESO database 265. The RESO database 265, in one embodiment, contains a record for each RESO and includes fields such as status, property information, tracking number, timestamp, detail stock offer, expiration date, conditions, and real estate owner ID number.

The status field, in one embodiment, has values of “pending,” “active,” “expired,” and “completed.” A status of “pending” means that the RESO is not currently available to potential investors. This may be the case because the RESO is either still being processed by central controller 200, or perhaps the real estate owner has temporarily suspended the RESO.

An “active” RESO becomes available to potential investors and can be bound. An “expired” RESO can no longer be bound. Once the RESO has been purchased by an investor, the RESO is given a status of “completed.”

After being stored at step 720, the RESO may go through a series of processing steps. One step, if necessary, is language translation. Language translation may include either creating an equivalent RESO in a standard language for the system, or translating the RESO to a common language that is viewable by investors. Language experts at central controller 200 provide the translation. Alternatively, automatic translation software such as Systran Professional, manufactured by Systran Software, may be used. Many bidirectional language combinations are available, including English to/from French, Italian, German, Spanish, Portuguese, and Japanese. Another step, if necessary, is to edit for typographical and other errors. The central controller 200 may also again verify the information in the RESO with various third party systems 170.

At step 730, the status of the database record for the RESO is set to “active.” At step 740, the real estate location information of the RESO is extracted from the property information field. At step 750, the RESO is posted in an appropriate real estate location area. This allows, in one embodiment, the RESO system 211 to display the RESO only to the most appropriate investors. In a World Wide Web environment, the RESO system 211 has a web page for each real estate location or area. Thus, all RESOs for San Diego real estate, for instance, would be displayed on the San Diego web page. This presentation makes it much easier for potential investors to find appropriate RESOs, as they can go right to the real estate location of interest.

In an alternative embodiment, the RESO is electronically mailed to potential investors, either individually or in groups. Potential investors may optionally elect to receive all RESOs, only those RESOs in their real estate location area, or a subset of RESOs representing a particular investor specified condition. For example, an investor might request that all RESOs over $100,000 for San Diego be sent to them.

In embodiments where RESOs are being transmitted to investors, it is important to note that there are a number of hardware options for investor interface 400, some of which have been noted above in the description of FIG. 4. Suitable investor interfaces 400 include fax machines, PDAs with wireless connections, beepers, or pagers. For example, an investor in England may instruct the central controller 200 to “beep” him whenever a RESO appears for a New York property. The investor may request that the central controller 200 provide details of the RESO over the beeper network. Alternatively, the investor may request that the central controller 200 inform the investor to log on to the central controller 200 for further details.

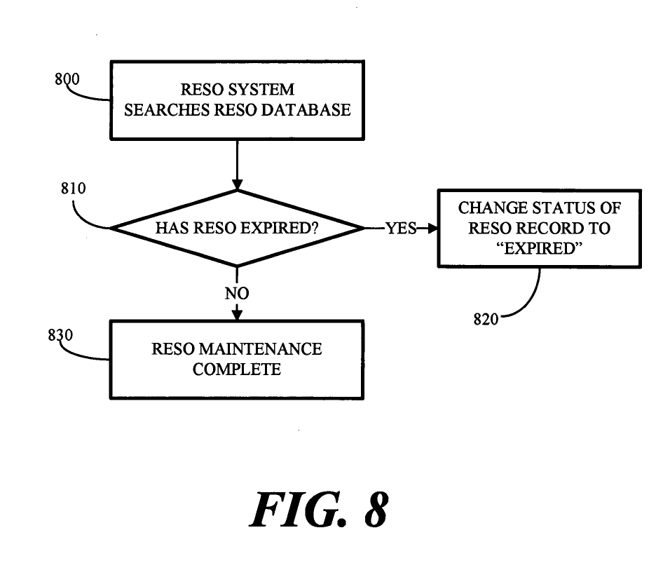

Turning now to FIG. 8, illustrated therein is one procedure for RESO maintenance in accordance with embodiments of the invention. At step 800, the RESO system 211 searches the RESO database 265. At step 810, the expiration date field of each database record is compared to the current date. If the expiration date of the RESO is earlier than the current date, the status of the RESO is changed to “expired” at step 820. The maintenance process is completed at step 830 once all “active” RESO database records have been examined.

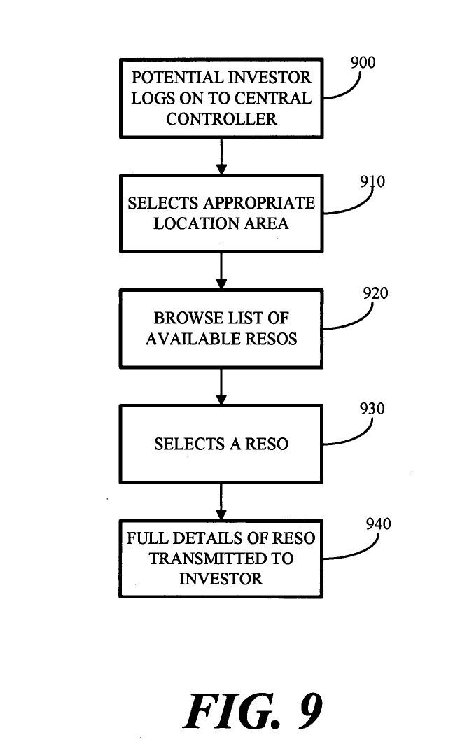

Turning now to FIG. 9, illustrated therein is one embodiment of a method by which a potential investor selects a RESO in accordance with the invention. At step 900, the potential investor logs onto the central controller 200 using the network interface 450 of the investor interface 400. At step 910, the potential investor selects an appropriate real estate location area. For example, an investor may select the Portland, Oreg. area when it is experiencing a real estate boom. As such, the investor may search the Portland real estate area in hope of finding an appropriate RESO.

At step 920, the potential investor browses the list of available RESOs (i.e. those with a status of “active”). The RESOs, in one embodiment, are listed with minimal details. Additional information is available where selected by the investor or where the potential investor is interested in purchasing a particular RESO. Continuing with the Portland, Oreg. RESO example from the preceding paragraph, a corresponding RESO might be listed as “Portland, Oreg.-50%-5 years-$100,000.”

At step 930 the potential investor selects a specific RESO. The potential investor may request additional data at step 940. In one embodiment, each RESO is hyperlinked to a separate web page. That web page may provide complete details or information. Upon accessing the web page, the potential investor may click on the RESO and be immediately transferred to a page or pages of supporting detail. This supporting detail may include a picture of the real estate parcel, historic price data for the area, sales statistics, comparable sales information, and so forth. In an alternate embodiment, the RESO is electronically transmitted directly to the investor. Transmission methods include electronic mail, fax, telephone, beeper, or other communication means.

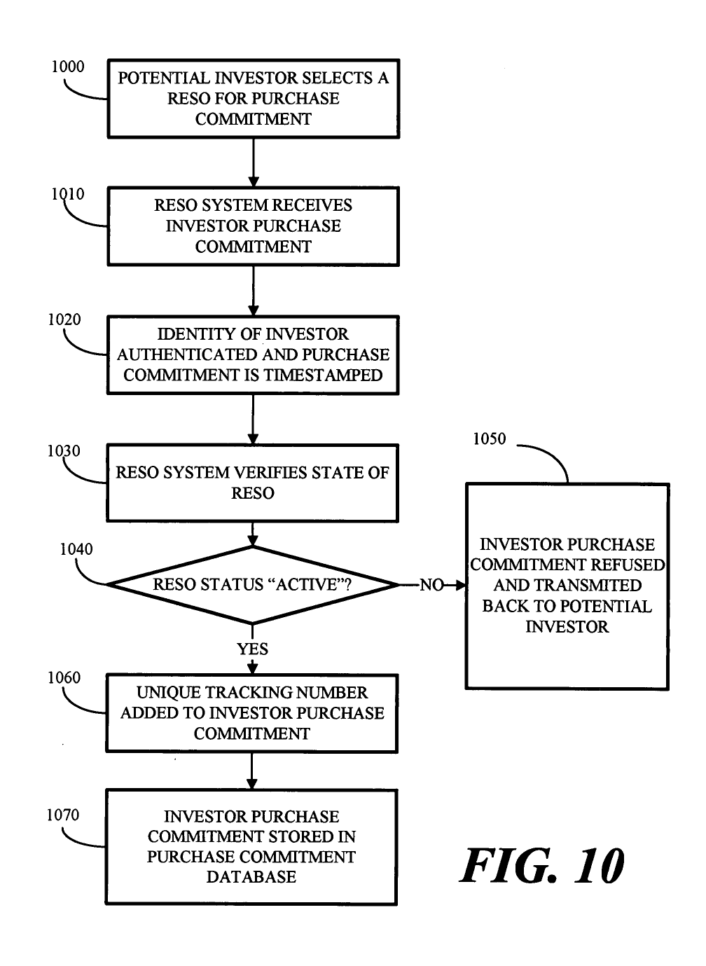

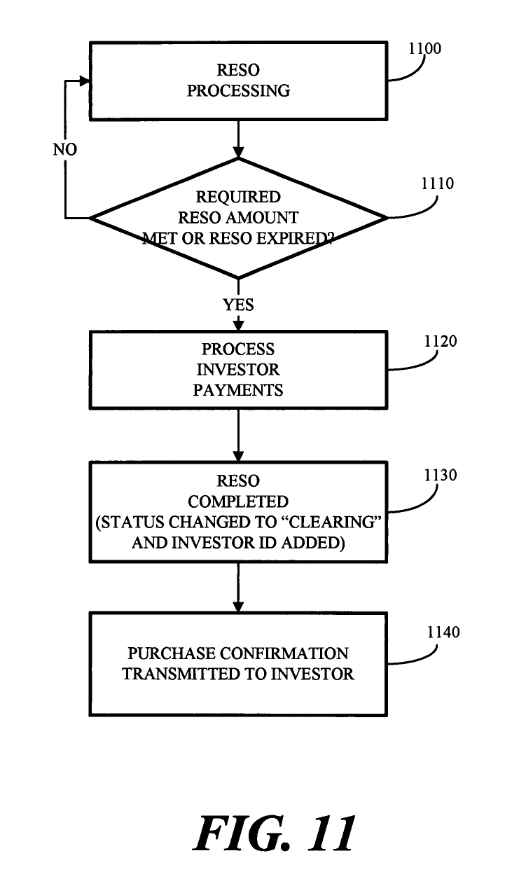

Turning now to FIGS. 10 and 11, illustrated therein is one method by which an investor purchases a RESO in accordance with embodiments of the invention. At step 1000, the potential investor selects the RESO to be purchased. This selection generations an investor purchase commitment 120 representative of his intention to invest. At step 1010, the RESO system 211 receives the investor purchase commitment 120 from the potential investor. The RESO system 211 then timestamps investor purchase commitment 120 and authenticates the identity of the investor using membership system 209, as well as verifying his probable capacity to deliver the necessary funds, at step 1020. The timestamp allows the RESO system 211 to determine the order in which investor purchase commitments 120 are to be processed. If two investor purchase commitments 120 are received within a few seconds of each other, the timestamp allows the RESO system 211 to decide which was received first. Alternatively, the timestamp may be appended to the investor purchase commitment 120 at the time it is transmitted from investor interface 400, using the clock 435 of the investor interface 400.

Authentication of the investor's identity involves the central controller 200 extracting the unique system ID from investor purchase commitment 120 and looking up the investor's identity in the investor database 260. Information in the investor database 260 then provides an indication of the investor's ability to deliver the required funds. Before an investor can complete an investor purchase commitment 120 in amount of $1,000, for example, central controller 200 must authenticate that the investor has $1,000 in available funds. If necessary, central controller 200 may verify that the investor can provide the specific funds required by contacting the bank interface 180. In another embodiment, the investor incorporates the investor purchase commitment 120 into the RESO. The investor may further sign the RESO by adding an electronic signature or other indication. This indication could be a digital signature, or could involve adding a symbol or indicia representative of the investor.

The RESO system 211 then verifies the status of RESO at step 1030, determining whether or not the status of the RESO is “active” at step 1040. If the RESO is currently “active,” a unique tracking number is added to the investor purchase commitment 120 at step 1060. The RESO system 211 then stores investor purchase commitment 120 in the purchase commitment database 268 at step 1070. If the status of RESO is not “active” at step 1040, the central controller 200 refuses the investor purchase commitment 120 and transmits the investor purchase commitment 120 back to the potential investor at step 1050.

Turning now to FIG. 11, illustrated therein is one embodiment of a RESO completion process in accordance with embodiments of the invention. The RESO completion process begins at RESO processing step 1100. The central controller 200 checks the validity of the RESO at step 1110. The central controller 200 processes payments when sufficient amount of investor purchase commitments 120 have posted for a specific RESO, or where the RESO reached the expiration date. The central controller 200 may additionally process payments where the real estate owner has agreed to any amount less than the original RESO amount. In such a case, the RESO may retain its status of “active” until a sufficient number of investors have responded. Once a sufficient number of investors have responded, the status of the RESO is changed to “clearing.”

At step 1120, the clearing system 213 processes the investor payment information and the approval code for the selected RESO. This information and approval code is transmitted to the bank interface 180 for a withdrawal of funds initiated by investor when completing the investor purchase commitment 120. Once the payment transfer is completed at step 1130, the RESO is completed and bound, and the RESO has effected a property transfer between the real estate owner and investor. The binding process requires that the status of RESO 110 be changed to “completed,” thereby preventing subsequent investors from purchasing already sold RESOs. The binding process also requires that the unique investor identifier be added to the RESO. At step 1140, the central controller 200 sends a purchase confirmation 130 to the investor and real estate owner.

In accordance with embodiments of the invention, there are many methods by which the provider of the system may generate revenue. In one embodiment, a flat fee is charged for every RESO that is submitted. There may also be flat fees for a predetermined number of RESOs submitted within a given period of time, thereby allowing investors to subscribe to the service much in the same manner as they might subscribe to a newspaper.

In another embodiment, the central controller 200 calculates a percentage of the amount paid by investors or received by real estate owners. Upon calculation, the central controller 200 may actuate a program to retain that percentage amount. Alternatively, methods and apparatuses of the present invention may be deployed without a payment feature.

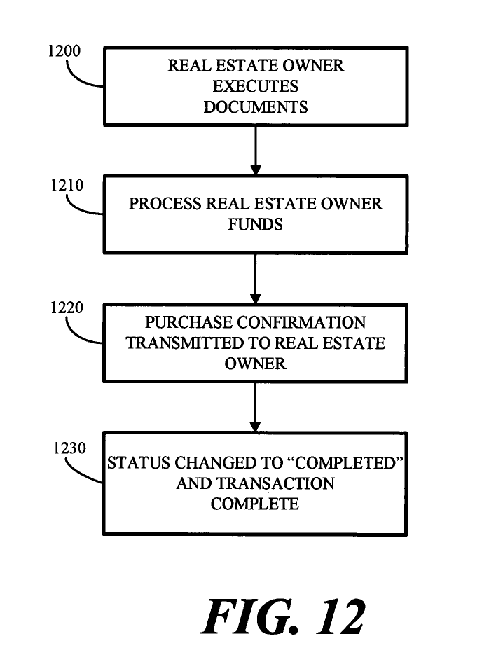

Turning now to FIG. 12, illustrated there are the remaining steps of RESO process completion. At step 1200, the real estate owner signs binding documents specified by the RESO terms and conditions. At step 1210, real estate owner payment information and an approval code are processed by clearing system 213 and transmitted to the bank interface 180 for deposit of funds. At the step 1220, the central controller 200 sends purchase confirmation 130 to the real estate owner. At step 1230, the status of the RESO is changed to “completed” and the transaction is complete.

In one embodiment of the invention, communications between investors take place across electronic networks, with the central controller 200 acting as a liaison, broker, or communication web server. To provide liquidity for real estate stock sold through the system, embodiments of the invention provide investors with a mechanism for selling the real estate stock at any time. To sell stock, the investor first logs on to the central controller 200 and creates an investor sale offer (ISO) 140 or investor purchase offer (IPO) 145. The ISO or IPO is then made available to potential investors by posting on a web page presented by the central controller 200. The central controller 200 may additionally provide periodic maintenance to ensure that active ISOs or IPOs have not expired. The central controller 200 may monitor the ISOs and IPOs for matches. Where a match is found, the central controller 200 completes transfer of real estate stock from one investor to another. The central controller 200 additionally transfers payments between buyers and sellers at the time of real estate stock transfer.

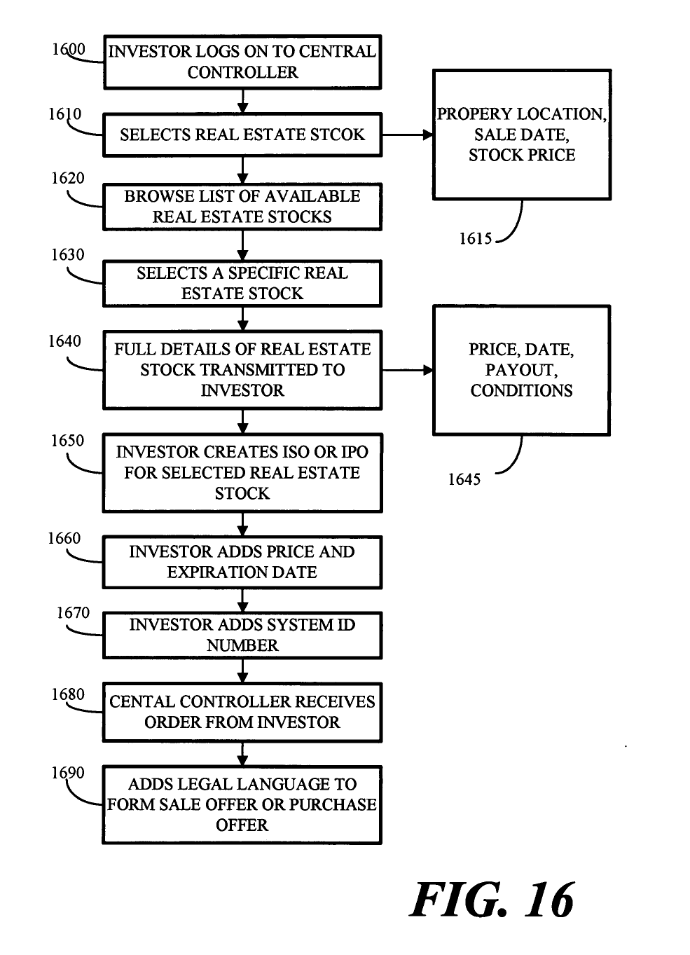

Turning now to FIG. 16, illustrated therein is one method by which an investor formulates the ISO or the IPO in accordance with embodiments of the invention. At step 1600, the investor logs on to the central controller 200 using the investor interface 400, thereby establishing a communication link with the central controller 200. It should be noted that the investor may be any of an individual, a corporation, a partnership, a government, or other entity. In one embodiment, the central controller 200 has a page on the World Wide Web, thereby allowing the investor to provide information through the interface of conventional web browser software such as Internet Explorer, manufactured by Microsoft Corporation.

At step 1610, the potential investor selects an appropriate real estate stock using real estate stock query 138. An investor, for example, who lives in Boston and wants to diversify his real estate investment portfolio, may wish to invest $10,000 into residential real estate located in Austin, Tex. At step 1620, this potential investor browses the list of available real estate stocks in the Austin area. Real estate stocks may be listed with minimal details, with additional information available only where the potential investor requests such information. An Austin, Tex. real estate stock might be listed as “Austin, Tex.-50%-Jan. 15, 2017-$125.” As shown in box 1615, the investor may search real estate stocks in accordance with a multitude of parameters. These parameters may include property address, residential or commercial description, date committed, current value, stock price, and so forth.

At step 1630 the potential investor selects a specific real estate stock. Where additional information is required, the investor may request such additional data at step 1640. In one embodiment, each real estate stock listing is hyperlinked to a separate web page that provides complete parcel/stock details. This detail may include a picture of the underlying real estate parcel, historic price data for the area, ISOs and IPOs open for that stock, and so forth. In another embodiment, real estate stock details are electronically transmitted directly to the investor. Transmission means include electronic mail, fax, telephone, beeper, or other communication devices.

As indicated in box 1645, the real estate stock listing may include a provision that the stock can be re-purchased. Additionally, the listing may include a minimum term date, a total amount offered, a percentage of equity share, or other terms that constitute conditions or covenants of the real estate stock. Such conditions may have been defined when the RESO was issued.

At step 1650, the investor chooses to issue either the ISO or the IPO for a specific real estate stock. After the necessary information has been provided, a form is displayed on the video monitor 430 of the investor interface 400. This form is an electronic contract with a number of blanks to be filled out by investor. Each blank represents a condition of the ISO or the IPO. The investor simply fills in the blanks.

At step 1660, the investor adds an expiration date and price to the ISO or the IPO, if desired, or chooses to execute transaction at prevailing price. This selection allows the investor to post the ISO or the IPO without worrying that he will later be bound when needs may have changed or his offer price has not been matched.

At step 1670, the investor attaches his name or a unique system ID number to the ISO or the IPO. This unique system ID, in one embodiment, is received from central controller 200 when the investor registers for the service. Alternatively, the unique system ID is chosen by the investor and then registered with central controller 200 by phone. The central controller 200 maintains a database of investor unique system ID numbers in the investor database 260, and issues (or allows) only unique numbers. If less security is required, the investor's social security number could serve as the unique ID number since it has the advantages of being both unique and easily remembered.

The investor then transmits the identifier to the central controller 200 at step 1680. The investor does this by clicking a “send” button located on the screen. At step 1690, boilerplate or form language is added to the ISO or IPO to complete them. The boilerplate language is pulled from the contract detail database, which stores such paragraphs.

As an alternative to a networked interface, such as a World Wide Web-based interface, the investor may also transmit the ISO or the IPO data via electronic mail, voice mail, facsimile, or postal mail transmissions. With a voice mail embodiment, the investor calls central controller 200 via telephone and leaves the ISO or the IPO in audio form. The ISO or the IPO may be transcribed into digital text at the central controller 200, or may be made available in audio format. In a postal mail embodiment, the central controller 200 acts more like a router, directing the ISO or the IPO to the potential investors, thereby creating multiple copies of the ISO or the IPO if necessary. The ISO or the IPO may also be posted to bulletin boards or web pages operated by central controller 200.

In one embodiment, the central controller 200 supports a plurality of transmission methods, allowing for a wide variety of electronic IPO or ISO formats. Some formats may be changed, however, before further processing by central controller 200. For instance, the ISO or the IPO may be transmitted by mail in paper form, or may be scanned-in and digitized using optical character recognition software to create digital text.

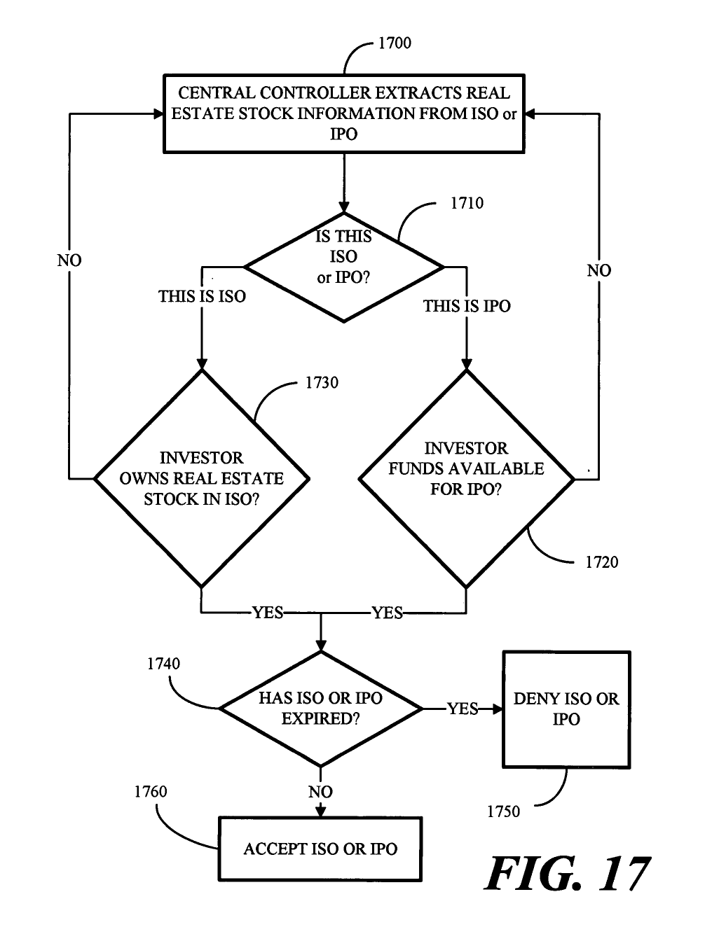

Referring now to FIG. 17, illustrated therein is a method of validating and publishing the ISO or the IPO in accordance with embodiments of the invention. At step 1700, the central controller 200 extracts real estate stock information from the ISO or the IPO. At step 1710, the central controller 200 chooses a validation path based on type of ISO or IPO. If offer is an IPO, the central controller 200 validates whether the necessary funds are available in the investor account at step 1720. If funds are not available to cover amount in the IPO, a balance amount required to complete the transaction is transmitted to the investor at step 1720. Once additional funds have been deposited, and the ISO or the IPO is updated and transmitted, the central controller 200 then resubmits the request for validation at step 1700.

If the offer is an ISO, the central controller 200 validates whether the investor owns the real estate stock, and whether it is available in an account at step 1730. If the investor does not own the corresponding real estate stock, or if the corresponding real estate stock is not available in the investor account, notice of such is transmitted to investor at step 1730. Once the necessary real estate stock is deposited and the ISO is updated and transmitted, the central controller 200 resubmits the request for validation at step 1700. Additionally, the ISO or the IPO is checked to see whether expiration has occurred at step 1740. If expired, the ISO or the IPO is rejected at step 1750 and returned to the investor. If the ISO or the IPO has not yet expired, it is accepted at step 1760.

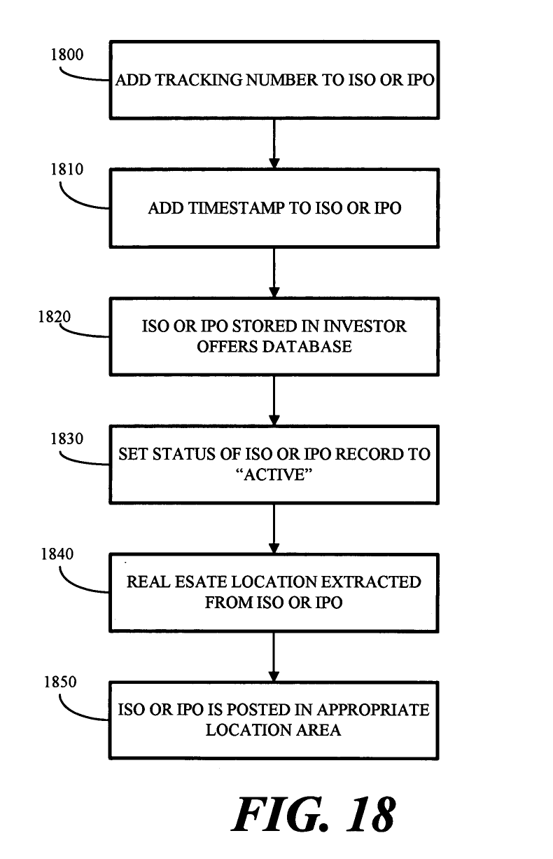

Turning now to FIG. 18, illustrated therein is one embodiment of a method with which an ISO or an IPO is activated and published in accordance with the invention. At step 1800, a unique tracking number is added to the ISO or the IPO. The central controller 200 timestamps the ISO or the IPO at step 1810, and then stores the ISO or the IPO in the investor offers database 270. The investor offers database 270 contains a record for each ISO or IPO, and includes fields such as status, real estate stock information, tracking number, timestamp, price, expiration date, conditions, and original RESO unique ID number if available.

The status field has values of “pending,” “active,” “expired,” and “completed.” A status of “pending” means that the ISO or the IPO is not currently available to other investors. This may be the case while central controller 200 is still processing the ISO or the IPO, or where the investor has temporarily suspended the ISO or the IPO. An “active” ISO or IPO is available to other investors and can be executed. An “expired” ISO or IPO can no longer be bound. Where investors have completed the ISO or the IPO, the status is marked “completed.”

The status of the database record for the ISO or the IPO is set to “active” at step 1830. At step 1840, the real estate location information of the ISO or the IPO is extracted from the real estate property information field. At step 1850, the ISO or the IPO is posted in an appropriate real estate location area. This posting allows the central controller 200 to display the ISO or the IPO only to the most appropriate investors.

In an on-line, networked environment, such as a World Wide Web environment, the central controller 200 has a web page for each possible real estate location area. Thus all ISOs or IPOs for San Diego, Calif. properties may be displayed on a corresponding San Diego web page. This makes it much easier for potential investors to find appropriate ISOs or IPOs as they are able to go precisely to the real estate location of interest.

In an alternative embodiment, the ISO or the IPO is electronically mailed to potential investors, either individually or in groups. Potential investors may elect to receive all ISOs or IPOs. Alternatively, the potential investors may elect to receive only those ISOs or IPOs in a pre-requested real estate location. Investors may elect to receive only a subset of ISOs or IPOs representing a particular condition. For example, an investor might request that all ISOs or IPOs under $100 in the greater metropolitan San Diego area be sent to them.

Where ISOs or IPOs are being transmitted to investors, it is important to note that there are a number of hardware options suitable for the investor interface 400, some of which have already been recited. Some suitable investor interfaces 400 include fax machines, PDAs with wireless connections, beepers, or pagers. For example, an investor in England could instruct the central controller 200 to beep him whenever an ISO or IPO appeared for a New York property. The investor may further request that details of the ISO or the IPO be transmitted over the beeper network. The investor may request that a notice informing the investor to log on to the central controller 200 be sent as well.

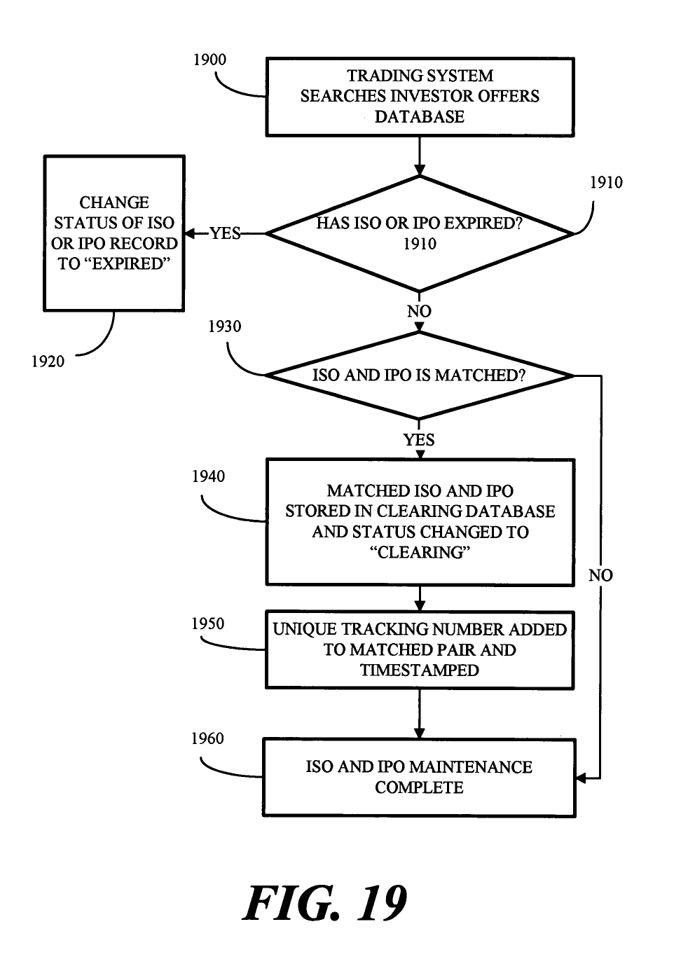

Turning now to FIG. 19, illustrated therein is one method of maintaining ISOs or IPOs in accordance with embodiments of the invention. At step 1900, the trading system 212 searches the investor offers database 270. At step 1910, the expiration date field of each database record is compared to the current date. If the expiration date is earlier than the current date, the status of the ISO or the IPO is changed to “expired” at step 1920.

At step 1930, the trading system 212 attempts to match “active” ISO to “active” IPO, and vice versa. If match is found, at step 1940 the trading system 212 records the ISO or the IPO match in the clearing database 290. Where an entire amount requested by the ISO is covered by the IPO, the status of the selected ISO and IPO are changed to “clearing” status. Otherwise the ISO amount is reduced by IPO amount.

A new record stored in the clearing database 290 receives a unique tracking number and timestamp at step 1950. The new record is marked “open”. The timestamp allows the central controller 200 to determine the order in which clearing should be processed. If two ISO and IPO matches are found within a few seconds of each other, the timestamp allows the central controller 200 to decide which was first. If no match is found, the trading system 212 proceeds to step 1960. The maintenance process is completed at step 1960 once all “active” ISOs or IPOs database records have been examined.

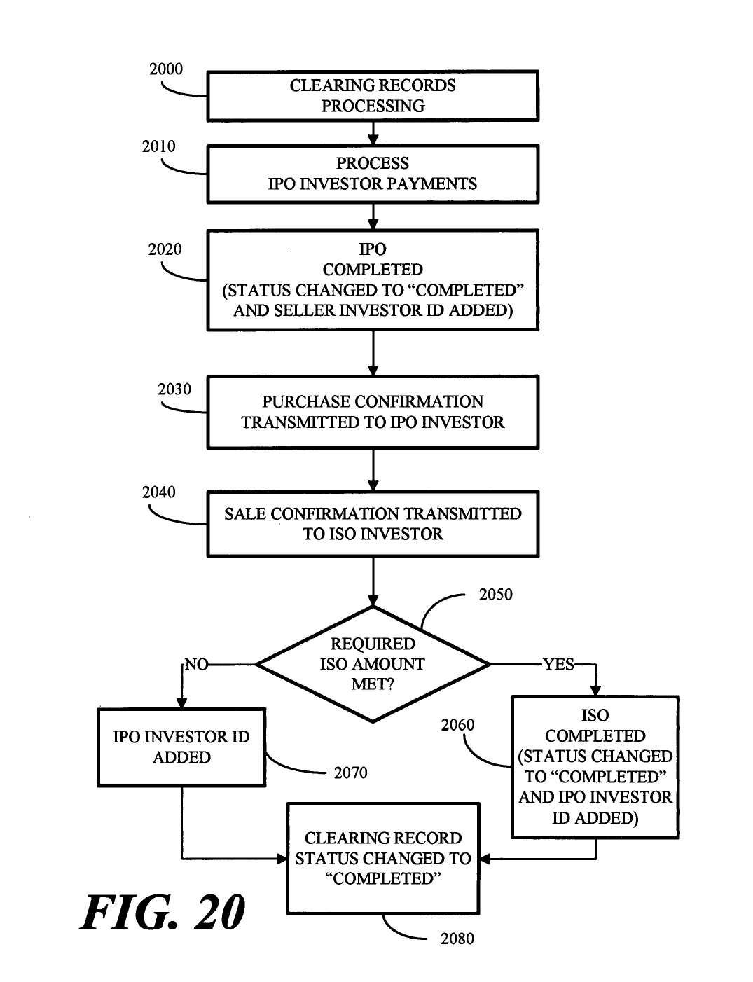

Turning now to FIG. 20, illustrated therein is a process by which matched clearing records in the clearing database 290 are processed in accordance with embodiments of the invention. The completion process begins at step 2000. This process clears records that have a status of “open.”

At step 2010, buyer payment information and an approval code for the selected clearing record is processed by the clearing system 213. Additionally, funds are transferred from the buyer account to the seller account. Once payment transfer is completed, at step 2020 the clearing record is completed and the IPO is bound, turning the IPO into a legally binding contract between the investors in the transaction. At step 2030, the clearing system 213 sends a purchase confirmation 130 to the investor. A sale confirmation 150 is then sent by the clearing system 213 to the investor at step 2040. At step 2050, the central controller 200 verifies whether the amount requested by the ISO has been met. If the entire ISO amount has been covered by the IPO, then the ISO status is changed to “completed” and the appropriate investor unique ID number is added to the underlying RESO.

The binding process requires that the status of the IPO be changed to “completed.” The binding process also requires that the corresponding IPO investor unique ID number be changed on the corresponding RESO to reflect a new owner of the real estate stock. If only a partial amount of the amount requested by the ISO is covered by the IPO, the central controller 200 at step 2070 adds the appropriate IPO investor unique ID number to the RESO record associated with the ISO. At step 2080, the clearing record status is changed to “completed.”

As with the RESO system, there are many methods by which the providers of the ISO and IPO system might generate revenue. In one embodiment, a flat fee is charged for every ISO or IPO that is matched. There may also be flat fees charged to cover a predetermined number of ISOs or IPOs over a given period of time, thereby allowing investors to subscribe to the service much as they would subscribe to a newspaper. In another embodiment, the central controller 200 calculates a percentage of the amount paid by investors. In such a scenario, the central controller 200 retains a percentage of that amount. Alternatively, the method and apparatus of the present invention may be employed without a payment feature.

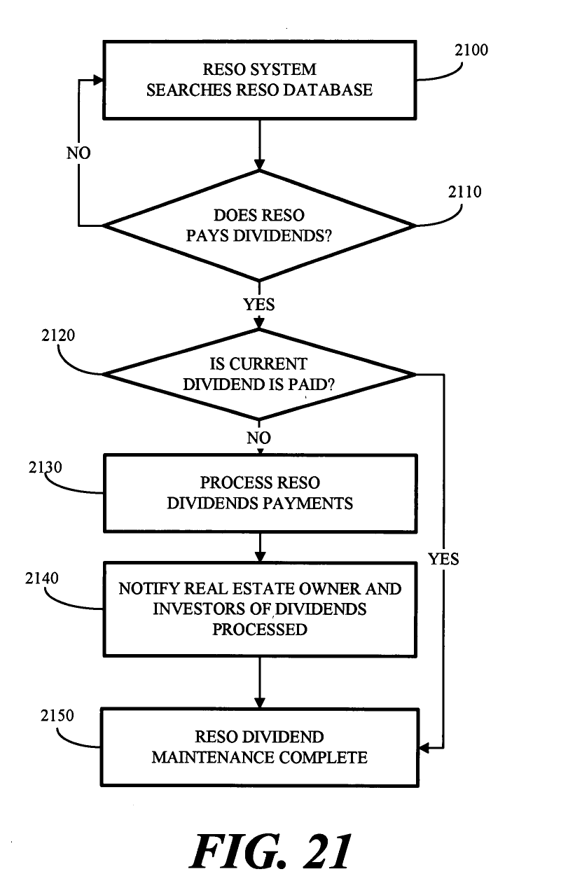

Turning now to FIG. 21, illustrated therein is one method for processing dividend payments in accordance with embodiments of the invention. Such dividends may be associated with the particular RESO. At step 2100, the RESO system searches the RESO database 265 for RESOs that pay dividends. At step 2110, the RESO system 211 confirms whether a selected RESO pays dividends. If no dividends are paid with a RESO, the RESO system 211 returns to step 2100 and continues searching the RESO database 265. If dividend payments are required, at step 2120 the RESO system 211 checks to see if current dividends have been paid. If the required dividends have been paid, at step 2150 the RESO dividend maintenance process is complete. If dividends were not paid, at step 2130 the RESO system 211 processes the RESO dividend payments by withdrawing money from the real estate owner account database 275 and depositing it into accounts of the appropriate investors on record with the RESO in the investor account database 276. At step 2140, RESO system 211 notifies real estate owner of RESO 110 and investors on record of dividends processed. At step 2150, RESO 110 dividends maintenance is complete.

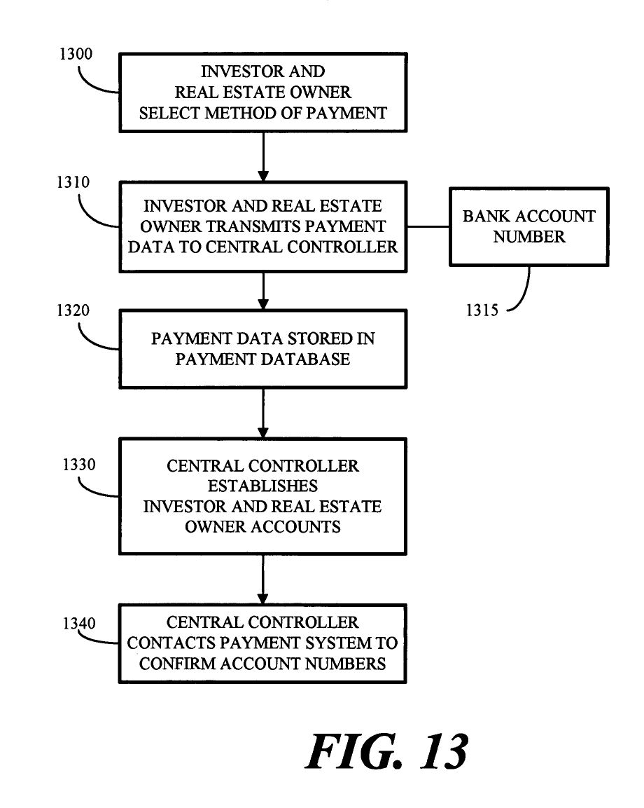

Turning now to FIG. 13, illustrated therein is one embodiment of a method by which the central controller 200 establishes the investor account database 276 and real estate owner account database 275 in accordance with the invention. At step 1300, the investor or real estate owner selects his preferred method of payment. Preferred methods might include personal checks, electronic bank funds transfer, digital money, and so forth. At step 1310, the investor or real estate owner transmits payment data corresponding to his preferred method of payment to the central controller 200. As indicated at step 1315, such payment data might include bank account number. These payment methods are merely illustrative. It will be clear to those of ordinary skill in the art having the benefit of this disclosure that many equivalent payment methods may also be used. If the investor or real estate owner wants to pay by debit card, for example, payment data would include his debit card account number, expiration date, name on the card, and security pin. For electronic funds transfer, payment data includes bank information and an account number. At step 1320, the central controller 200 stores payment data and payment preferences in payment database 285.

At step 1330, the central controller 200 establishes the investor account database 276 and the real estate owner account database 275. These databases are used to store money transferred by the investor or real estate owner. The databases may include a pointer to an account belonging to the investor or real estate owner that exists outside the system. The investor may transfer money to the central controller 200 to be stored in investor account database 276, which would operate like a conventional checking account. The central controller 200 sends a check to the real estate owner that is written against investor account database 276. Alternatively, the central controller 200 may electronically move the funds directly from the investor account database 276 to the real estate owner account database 275.

At step 1340, the central controller 200 contacts the payment system to confirm that account numbers are valid. An investor is thus unable to make investor purchase commitments 120 with no credit available in the investor account database 276. Account information may also be embedded in the RESO or the investor purchase commitment 120, thereby allowing the central controller 200 to complete payment once RESO 110 is completed.

Another method of payment involves procedures using digital cash. The central controller 200 looks up the investor's electronic delivery address in the payment database 285. This address is transmitted to the clearing system 213, with the digital cash being downloaded from the investor. The central controller 200 updates the payment database 285 to indicate that payment has been made. This address might be an electronic mail address if the digital cash is to be transferred by electronic mail, or it may alternatively be an Internet Protocol address capable of accepting an on-line transfer of digital cash. This electronic delivery address is sent to the clearing system 213. The digital cash is downloaded to the investor account database 276 or directly to the investor. The central controller 200 then updates payment database 285 to indicate that payment has been made. Using these digital cash protocols, it is possible for the investor to include payment along with investor purchase commitment 120 in electronic form. The practice of using digital cash protocols to effect payment is well known in the art and need not be described here in detail. For reference, refer to Daniel C. Lynch and Leslie Lundquist, Digital Money, John Wiley & Sons, 1996; or Seth Godin, Presenting Digital Cash, Sams Net Publishing, 1995.

While the networked, on-line embodiments of the invention describe a protocol in which investors make payment immediately upon making a purchase commitment 120, other embodiments may be implemented where payment is delayed until the RESO has been completed. Alternatively, payment may be delayed until some predetermined date. Partial payments and installment payments are also supported by the system.

The escrow account database 299 allows payment to be delayed until the RESO, ISO or IPO is completed. This delay may occur while the real estate owner completes delivery of the RESO, or while the investor completes delivery of real estate stock and funds. The central controller 200 establishes records in the escrow account database 299 as temporary holding records. When the investor makes purchase commitment 120 for a RESO, funds are transferred from the investor account database 276 to the escrow account database 299. Only after the real estate owner executes the RESO are funds transferred from escrow account database 299 to real estate owner account database 275. The investor may transmit a digitally signed release message to the central controller 200, thereby authorizing the release of the escrowed funds to the real estate owner.

In another embodiment, the investor makes a partial payment when the purchase commitment 120 for a RESO made. The investor then completes payment when the RESO is completed. The fraction of the offered price of the RESO, in one embodiment, is to be paid upon binding the purchase commitment 120. The price is stored in the payment database 285 when the purchase commitment 120 is bound. The central controller 200 releases this portion of the funds at step 1120, and then releases the remaining portion after the RESO is completed at step 1200. The partial payment made may be non-refundable. This would allow the central controller 200, for example, to accept other investor purchase commitments 120 as back up commitments.

In yet another embodiment, the purchase commitment 120 describes the use of installment payments. The first payment is made when purchase commitment 120 is bound, followed by regular payments as specified in the conditions of the RESO. The dates at which payments are to be made are stored in the payment database 285.

In one embodiment of the present invention, investors respond to the RESO not by binding it, but by making a counteroffer with modified and/or additional conditions. An investor, for example, might view a RESO offered at one hundred thousand dollars. The investor may be willing to make purchase commitment for fifty thousand dollars. As such, rather than passing on the RESO, the investor may wish to issue a counteroffer. This counteroffer is similar to the RESO except for the fact that the investor is binding the real estate owner instead of the real estate owner binding the investor. The counteroffer is also directed to a specific party (the real estate owner), unlike the RESO that is directed to a plurality of investors.

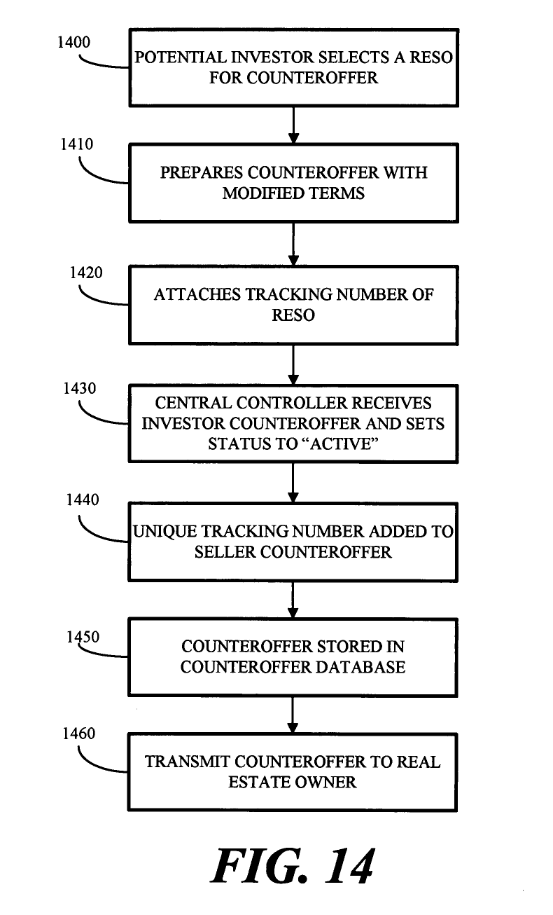

Turning now to FIG. 14, illustrated therein is a method for developing a counter offer in accordance with embodiments of the invention. At step 1400, the potential investor selects a RESO for which he wishes to make a counteroffer. At step 1410, the investor prepares the counteroffer with modified conditions. The investor follows the same process that the real estate owner uses to generate the RESO, as set forth in steps 500 through 580 of FIG. 5, selecting the terms and conditions as appropriate. Alternatively, the investor may be presented with an electronic copy of the initial RESO. The investor may then be allowed to edit those conditions that the investor wants to change. For example, the investor might take the real estate owner request for hundred thousand dollars and counteroffer with fifty thousand dollars.

At step 1420, the investor attaches the tracking number of the RESO to investor counteroffer. The central controller 200 receives the investor counteroffer at step 1430, setting the status to “active.” The central controller 200 then adds a unique tracking number to investor counteroffer at step 1440, and stores the counteroffer in the RESO database 265 at step 1450. The central controller 200 then extracts the tracking number of the RESO attached to investor counteroffer to determine to which real estate owner the investor counteroffer should be transmitted at step 1460.

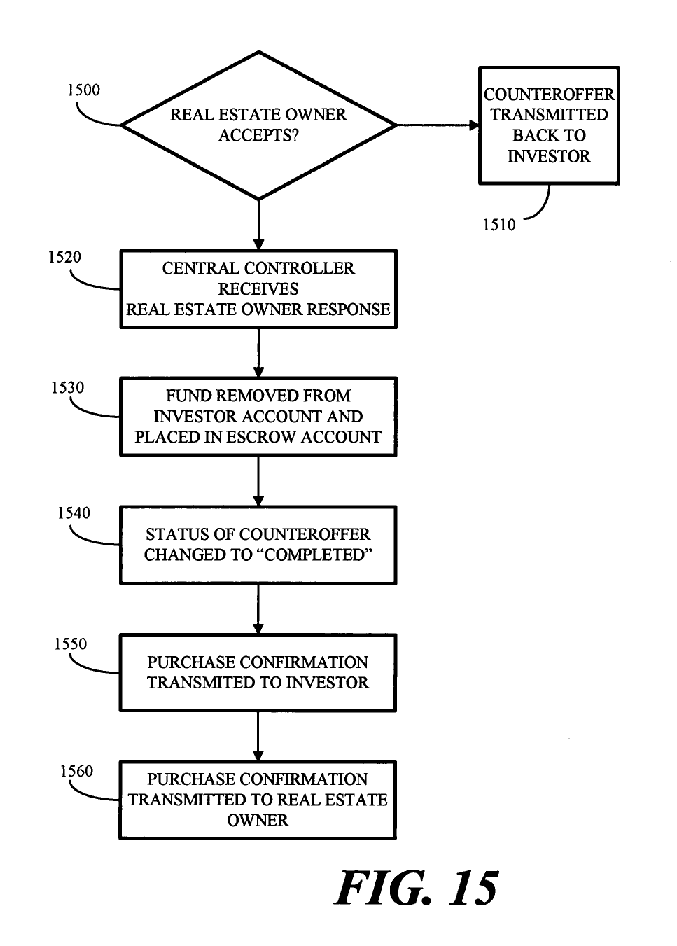

Turning now to FIG. 15, illustrated therein is one method by which the real estate owner responds to investor counteroffer in accordance with the invention. At step 1500, the real estate owner decides whether to accept the investor counteroffer. If he does not accept, the investor counteroffer is transmitted back to the investor at step 1510. If the real estate owner does decide to accept, a real estate owner acceptance 116 is transmitted to the central controller 200 at step 1520. At step 1530, funds are removed from investor account database 276 and placed in escrow account database 299. At step 1540, the status of investor counteroffer is changed to “completed.” Purchase confirmation 130 is then transmitted to the investor at step 1550, and on to the real estate owner at step 1560. Procedures for the completion of RESO are described in FIG. 12.

As noted above, in some embodiments of the invention, real estate owners and investors communicate in an off-line manner with central controller 200. Rather than sending electronic mail or using web-based servers, real estate owners and investors use a telephone, fax machine, postal mail, or other off-line communication tool.

A real estate owner may use a telephone, for example, to generate the RESO. In one embodiment, the real estate owner calls the central controller 200 and is connected with an agent. The real estate owner provides the terms of the RESO, including the amount, expiration date, and other terms set forth above. The real estate owner also provides his unique user ID, password, or private key so that the central controller 200 can authenticate his identity via the membership system 209. The agent puts this data into digital form by typing it into a terminal and then adds legal language to form the RESO. The RESO is then transmitted to the central controller 200 where it is made available to potential investors as described in the on-line embodiment. In an alternative embodiment, the real estate owner calls the central controller 200 and is connected with a conventional Interactive Voice Response Unit (IVRU), which allows the real estate owner to enter some or all of the terms of the RESO without the assistance of a live agent.

Potential investors may also use a telephone to browse RESOs, or to make investor purchase commitments 120. The potential investor calls the central controller 200 and selects a real estate location. The central controller 200 then converts the text of each RESO into audio form, reading the entire list to the potential investor. At any time during the reading of the RESOs, the potential investor may press a combination of keys on his telephone to select a RESO for purchase commitment. The investor enters investor ID number and is authenticated by the central controller 200 using the membership system 209 prior to making a purchase commitment 120. Potential investors may also enter parameters before having the list of RESOs read to them. An investor, for example, might request that all RESOs for more than hundred thousand dollars be read, skipping any RESO with a lower amount. Real estate owners and investors may also communicate with an agent at the central controller 200 through faxes or postal mail. The agent receives the message and proceeds to digitize it and form RESO as described above.

In the previous embodiments, authentication of the real estate owner and investor involves checking the attached ID or name and comparing it with those stored in the investor database 260 and real estate owner database 255. Although this procedure works well in a low security environment, it can be significantly improved through the use of cryptographic protocols. These protocols not only enhance the ability to authenticate the sender of a message, but also serve to verify the integrity of the message itself. Such techniques shall be referred to generally as cryptographic assurance methods, and will include the use of both symmetric and asymmetric keys as well as digital signatures and hash algorithms.

The practice of using cryptographic protocols to ensure the authenticity of senders, as well as the integrity of messages, is well known in the art and need not be described here in detail. For reference, refer to Bruce Schneier, Applied Cryptography, Protocols, Algorithms, And Source Code In C, (2d Ed, John Wiley & Sons, Inc., 1996).

Where using cryptographic protocols, all messages between the central controller 200 and the real estate owner interface 300 or investor interface 400 may be authenticated and encrypted using well-known methods and software. For example, when the central controller 200 is configured as a web server, conventional communications software such as the Internet Explorer web browser from Microsoft Corporation may be used to secure exchange messages between the central controller 200 and the real estate owner interface 300 or investor interface 400.

As mentioned previously, embodiments of the present invention may provide anonymity for both real estate owners and investors. Such anonymity, in one embodiment, is accomplished by eliminating all references to the names of the individuals and businesses for all transactions. A real estate owner, for example, may include his unique ID number in the RESO rather than his name, thereby preventing the investor receiving the RESO from discovering the real estate owner's identity. This is desirable where the real estate owner, for example, does not want his neighbors about his desire to obtain money from his real estate parcel. In a similar manner, investors may also want to keep their identity a secret. An investor might not want the public to know that they are investing in certain real estate.

Although using unique ID numbers can provide anonymity, security is heightened when the unique ID numbers are encrypted with a private key of the central controller 200. In such an embodiment, anonymity is protected even where a database is stolen.

Alternate embodiments for anonymity include telephone messaging. When talking on the telephone, the identity of the real estate owner and investor could be hidden using conventional voice modification techniques. If the RESO or investor purchase commitment is in paper form, the form could be scanned using optical character recognition and translated into digital form, discarding any information that could be found in the original document.

Not all transactions require the transfer of money from the investor to the real estate owner. In a barter transaction, the distinction between the real estate owner and the investor disappears, resulting in a contract for exchange between a first party and a second party. The first party posts the RESO and the second party posts a barter commitment to it. Instead of receiving cash, the first party receives real estate stock from the second party. A first party who wanted to post a RESO for a real estate parcel in Boston, for example, could post that RESO offering to exchange the real estate stock in Boston for a real estate stock in San Diego.

Although the previous embodiments have described the delivery of real estate stock from real estate owner to investor, and also the delivery of money from investor to real estate owner, there will inevitably be disputes arising from some transactions, requiring follow-up activity to resolve these disputes. The present invention can support dispute resolution in two ways.

First, language may be included—perhaps as boilerplate or form language—into every RESO. This language, in one embodiment, requires that both parties submit to binding arbitration of all disputes. Binding arbitration helps to avoid more costly and time-consuming legal battles. Additionally, liquidated damages may be set which specify damage amounts for particular infractions of the RESO.

Second, the central controller 200 can support the arbitration process by providing an arbiter for each dispute. Such arbitration might be required when real estate information in the RESO provided by the real estate owner to the investor does not act in accordance with the requirements of the RESO. An investor requiring owner-occupied land in a counteroffer, for example, might seek damages against an owner who leases property to tourists. Instead of seeking damages, the investor may seek a monetary reward, such as rebate or discount on the original RESO amount. In an arbitration involving real estate information, the investor may submit evidence to the central controller 200 along with the tracking number of the RESO 110, thereby allowing the arbiter to establish whether the real estate owner has fulfilled the conditions of the RESO.

In an alternative embodiment, transaction data can be sent to third party arbiters outside the system. The central controller 200 may send a copy of the RESO, investor purchase commitment, or purchase confirmation to the arbiters. Cryptographic keys may also be provided to the arbiters if there are questions of authenticity or non-repudiation.

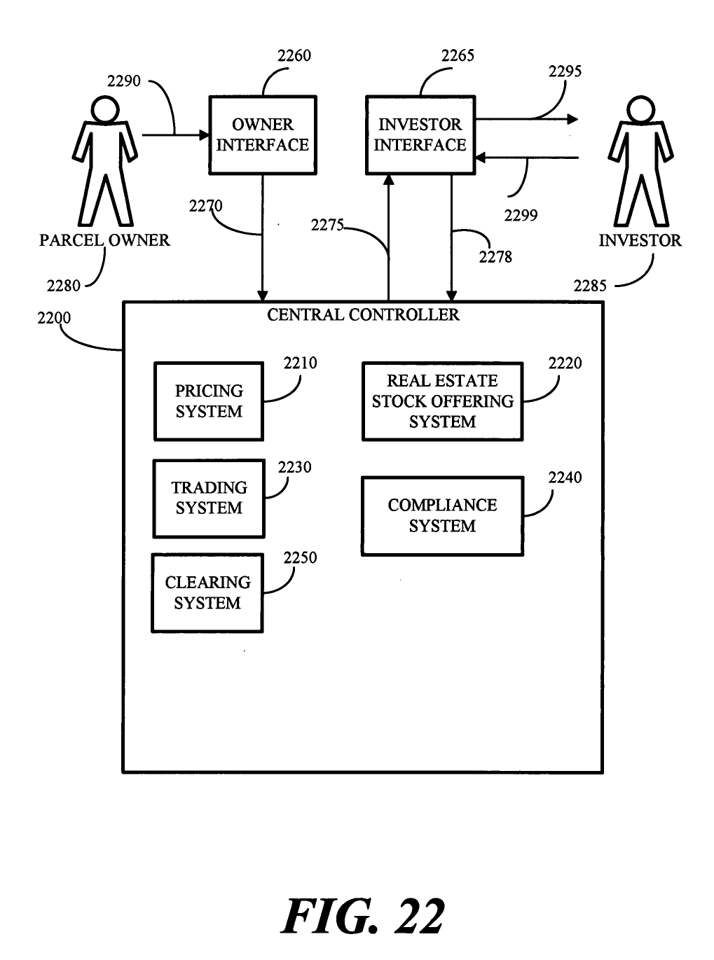

Turning now to FIG. 22, illustrated therein is one embodiment of a schematic block diagram illustrating a method of real estate stock sale management system for creating, marketing, and selling equity shares in accordance with the invention. As noted above, but illustrated in general form in FIG. 22, in one embodiment, a central controller 2200 includes a pricing system 2210, a real estate offering system 2220, a trading system 2230, a compliance system 2240, and a clearing system 2250. The pricing system 2210 is configured to process requests received by the networked, electronic, exchange apparatus for real estate parcel based stock offering prices. The pricing system 2210 is further configured to deliver one or more real estate parcel based stock offerings in response to the requests.

A real estate stock offering system 2220 is configured to process real estate owner's request to initiate real estate parcel based stock offerings. A trading system 2230 is configured to process purchase and sale of the real estate parcel based stock offerings. A clearing system 2250 is configured to process financial transactions associated with the purchase and sale of the real estate parcel based stock offerings. A compliance system 2240 is configured to maintain a record of central controller transactions.

The real estate parcel owner 2280 provides real estate parcel data 2290 to owner interface 2260. The owner interface 2260 submits the parcel data 2270 to the central controller 2200. In response, the central controller 2200 generates a real estate parcel based stock offer 2275 associated with the electronic real estate parcel data, and makes the real estate parcel based stock offer 2275 available to the investor interface 2265. Investors 2285 utilize the investor interface 2265 to view the real estate parcel based stock offers 2275. The investors 2285 also use the investor interface 2265 to generate purchase commitments 2299, which are submitted to the investor interface 2265. The investor interface 2265 then communicates the purchase commitments 2278 to central controller 2200 for processing.

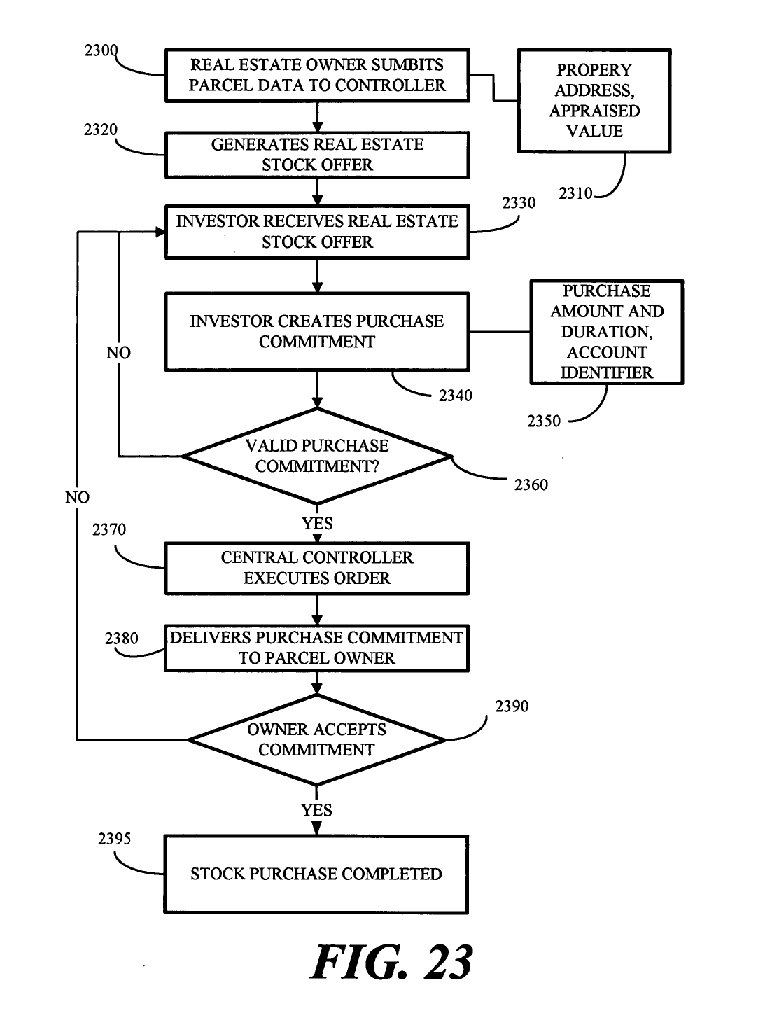

Now turning to FIG. 23, illustrated therein is a general embodiment of a method for creating, marketing, and selling equity shares in accordance with embodiments of the invention. At step 2300, a system hub, such as the central controller 2200, receives electronic real estate parcel data from the owner interface 2260. In one embodiment, the electronic real estate parcel data includes at least an address and the appraised value amount as shown at step 231 0. At step 2320, the central controller 2200 generates and delivers the real estate parcel based stock offer 2275 to the investor interface 2265. The central controller 2200 optionally adds a tracking number and time stamp to the real estate parcel based stock offer 2275. At step 2330, the investor 2285 reviews the real estate parcel based stock offer 2275 and may choose to purchase it. If the investor 2285 elects to purchase the real estate parcel based stock offer 2275, at step 2340 the investor 2285 creates a purchase commitment 2278 and submits it to the investor interface 2265. The real estate stock parcel based stock offer 2275, in on embodiment, includes at least a minimum purchase amount and an offering duration as show in step 2350.

The central controller 2200 validates the purchase commitment 2278 at step 2360. Validation may be performed to determine whether the purchase commitment 2278 exceeds the minimum purchase amount of the real estate parcel based stock offer 2275. Validation may also be performed to determine whether an offer duration has expired prior to receipt of the purchase commitment 2278. In addition, at step 2360 the central controller 2200 validates the minimum purchase amount and the offering duration against the purchase commitment 2278.

If the purchase commitment 2278 passes validation, the central controller 2200 executes it at step 2370 by retrieving an electronic financial account identifier associated with the purchase commitment 2278 from the investor interface 2265 and executing an electronic transfer of funds via the electronic financial account identifier. The central controller 2200 optionally adds a tracking number and time stamp to the purchase commitment as well. If the purchase commitment 2278 is not valid, notice of this invalidity is communicated back to investor 2285 at step 2330.

Once the central controller 2200 executes the order it is delivered to the parcel owner 2280 at step 2380 via the owner interface 2260. At step 2390, the parcel owner 2280 may choose to accept the purchase commitment 2278. Where accepted, the stock purchase is completed at step 2395. The parcel owner 2280 can issue a counteroffer as well. The central controller 2200 delivers any counteroffer to the investor interface 2265 at step 2330.

Embodiments of the present invention offer many advantages over prior art real estate financing solutions. A few of these advantages will be described here.

First, embodiments of the present invention do not rely on any one single financial entity to provide funds to borrowers to finance real estate property. Instead, funds are provided by plurality of investors, each investor participating in the upside of any appreciation of the value of their stock holdings in the real estate parcel.

Next, embodiments of the present invention in deal only with real estate parcel property and not commodities. Further, embodiments of the present invention do not offer trading of an entire property as a whole. To the contrary, a single real estate parcel is divided into plurality of stocks, which may be owned and traded by plurality of investors.

Third, embodiments of the present invention do not perform any pricing function—pricing is dictated purely by market forces. For example, pricing of a RESO is done based on obtained data, including property address and appraisal reports.

Next, embodiments of the present invention are not limited to institutional investors.

Individual investors may participate just as do institutional investors.

Next, embodiments of the present invention do not employ lend-lease agreements. To the contrary, equity shares are created in a single real estate parcel. Investors own these equity shares, without complex financial instruments like lend-lease agreements. Additionally, embodiments of the present invention do not employ option interests in real property. While some prior art systems have taught providing call options in exchange for payment, the present invention uses equity shares. Mortgages are not used either. Additionally, there are no third-party funds or pools of money required for equity ownership.

While, some prior art solutions propose third-party strawmen who owns a home and permit the homeowner to “rent back” in exchange for financing, embodiments of the present invention leave the homeowner as majority owner of the property with the associated benefits attached, including tax deductions. Title does not change on the property. Instead, systems and methods of the invention record liens against a parcel that reflect the monetary and contractual obligations. At the same time the property title and ownership maintained by the property owner.

Further, as noted above, embodiments of the present invention deal with a method of dividing a real estate parcel into equity shares and selling those shares to investors. The investors are then free to sell to others on an exchange. The present invention develops a multilateral buyer-seller driven system to exchange shares and works as a third party to administer a shared equity financing. By way of example, in addition do administering financing, the central controller of the present system can serve as a trusted arbitrator available to resolve any disputes, enforce established contracts and covenants, facilitate exchange of interests in a shared equity financing, and thereby increase buyer and seller confidence in the system and shared equity financing.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

What is claimed is:

1. An electronic system for creating, marketing, and selling equity shares, represented by stock in individual real estate parcels, between an owner of the individual real estate parcel and at least one of a plurality of investors, comprising:
a central controller, having a network interface coupled to a network, the central controller comprising a trading system configured to process purchase and sale of one of the real estate parcel based stock offerings or the equity;
an investor interface, coupled to the network interface across the network, configured to receive investor input; and
a real estate owner interface, coupled to the network interface across the network, configured to receive real estate owner input.

2. The electronic system of claim 1, wherein the central controller further comprises:
a pricing system configured process investor requests received by the electronic system for real estate parcel based stock offering prices, and to deliver one or more real estate parcel based stock offerings in response to the investor requests, wherein the pricing system is further configured to process offering requests received by the electronic system for stock offerings, and to deliver one or more stock offering options in response to the offering requests;
a clearing system configured to process financial transactions associated with the purchase and sale of the real estate parcel based stock offerings;
a compliance system configured to maintain a record of central controller transactions; and
a real estate stock offering system configured to process requests by real estate owners to initiate real estate parcel based stock offerings.

3. The electronic system of claim 1, further comprising a real estate information system communication coupling connected across the network between the central controller and a real estate information system, wherein the real estate information system communication coupling is configured to receive information validating real estate parcel value, existing debt and property condition from the real estate information system.

4. The electronic system of claim 1, further comprising a bank communication coupling connected across the network between the central controller and a bank, wherein the bank communication coupling is configured to receive information validating funds from the bank.

5. The electronic system of claim 1, further comprising a credit agency communication coupling connected across the network between the central controller and a credit agency, wherein the credit agency communication coupling is configured to receive information validating real estate owner personal information from the credit agency.

6. The electronic system of claim 1, wherein the central controller further comprises a membership system, a real estate owner database, and an investor database, wherein the membership system is configured to authenticate an identity of at least one real estate owner and at least one investor by matching identities of real estate owners stored in the real estate owner database with certain system users, and by matching identities of investors stored in the investor database with other certain system users.

7. The electronic system of claim 1, further comprising a real estate stock offering database, accessible by the central controller, wherein the central controller, upon receiving real estate parcel information from the real estate owner interface, is configured to invoke the real estate stock offering system to create a plurality of stock shares corresponding to the real estate parcel information, and to store them in a real estate stock offering database.

8. The electronic system of claim 7, wherein the central controller, upon receiving a request from the investor interface, is configured to invoke the pricing system to retrieve one or more stock shares from the real estate stock offering database, associate a price with the one or more stock shares, and to deliver the price to the investor interface.

9. The electronic system of claim 8, further comprising a plurality of databases, accessible by the central controller, the plurality of databases comprising at least a purchase commitment database for storing purchase commitments of the real estate parcel based stock offerings, and a clearing database for storing transaction data relating to the real estate parcel based stock offerings.

10. The electronic system of claim 9, wherein the central controller, upon receiving a purchase commitment from the investor interface, is configured to invoke the trading system to generate an identifier specifying at least a financial account, the identifier being associated with the purchase commitment, and to store the purchase commitment and the identifier in the purchase commitment database.

11. The electronic system of claim 10, wherein the central controller, upon the purchase commitment being stored in the purchase commitment database, is configured to invoke the clearing system to transfer funds from an investor account to a real estate owner account.

12. The electronic system of claim 9, further comprising a plurality of databases, the plurality of databases comprising one of a contract detail database, a real estate stock option database, and a payment database an audit database, an escrow database, and an investor offers database.

13. A method for creating, marketing, and selling equity shares, represented by stock in individual real estate parcels, between an owner of the individual real estate parcel and at least one of a plurality of investors, the method comprising the steps of:
providing a networked, electronic, exchange apparatus having a central controller, the central controller comprising:
a pricing system configured process requests received by the networked, electronic, exchange apparatus for real estate parcel based stock offering prices, and to deliver one or more real estate parcel based stock offerings in response to the requests;
a real estate stock offering system configured to process requests by real estate owners to initiate real estate parcel based stock offerings;
a trading system configured to process purchase and sale of the real estate parcel based stock offerings;
a clearing system configured to process financial transactions associated with the purchase and sale of the real estate parcel based stock offerings;
a compliance system configured to maintain a record of central controller transactions;
an investor interface; and
an owner interface;
receiving electronic real estate parcel data from the owner interface, the electronic real estate parcel data comprising at least an address and an appraised value amount;
generating a real estate parcel based stock offer associated with the electronic real estate parcel data; and
delivering the real estate parcel based stock offer to the investor interface.

14. The method of claim 13, further comprising the steps of:
receiving at least one purchase commitment from the investor interface in response to the step of delivering the real estate parcel based stock offer;
receiving an electronic financial account identifier associated with the at least one purchase commitment from the investor interface; and
executing an electronic transfer of funds via the electronic financial account identifier.

15. The method of claim 13, wherein the real estate stock parcel based stock offering comprises at least a minimum purchase amount and an offering duration.

16. The method of claim 15, further comprising the step of determining whether the purchase commitment exceeds the minimum purchase amount.

17. The method of claim 16, further comprising the step of determining whether the offering duration has expired prior to receipt of the at least one purchase commitment.

18. The method of claim 13, further comprising the steps of validating the electronic real estate parcel data and validating the at least one purchase commitment.

19. The method of claim 14, further comprising the steps of:
delivering the at least one purchase commitment to the owner interface upon receiving the at least one purchase commitment;
receiving additional transaction details from the owner interface; and
generating, electronically, a counteroffer and delivering the counteroffer to the investor interface.

20. The method of claim 13, further comprising the steps of adding a tracking number and time stamp to one of the real estate parcel based stock offering or the at least one purchase commitment.
